(19) United States
(12) Patent Application Publication
(10) Pub. No.: US 2014/0032259 A1
(43) Pub. Date: Jan. 30, 2014

(54) SYSTEMS AND METHODS FOR PRIVATE AND SECURE COLLECTION AND MANAGEMENT OF PERSONAL CONSUMER DATA

(71) Applicants: Malcolm Gary LaFever, Lyons, CO (US); Ted Nathan Myerson, New York, NY (US)

(72) Inventors: Malcolm Gary LaFever, Lyons, CO (US); Ted Nathan Myerson, New York, NY (US)

(21) Appl. No.: 13/764,773

(22) Filed: Feb. 11, 2013

Related U.S. Application Data
(60) Provisional application No. 61/675,815, filed on Jul. 26, 2012.

(51) Int. Cl. G06Q 30/02

(52) U.S. Cl. CPC G06Q 30/0201
USPC 705/7.29

(57) ABSTRACT

Computer systems and related methods for managing and protecting consumer data and increasing the accuracy of consumer purchasing alternatives by means of private and secure collection and management of personal online and/or offline consumer data from disparate data sources. In one example, a method for collecting information includes collecting and aggregating a plurality of data relating to a user from a plurality of unaffiliated data sources, wherein the data comprises data of varying formats. Collection of the data is performed in part under authorization by the user. The method may include normalizing the data into a standardized form. The method also includes generating an aggregated data profile associated with the user based on the data that is collected and aggregated. The aggregated data profile gives the user control over their personal data and, with express user permission, provides vendors with a comprehensive view of the user, their interests and characteristics.

### CROSS REFERENCE TO RELATED APPLICATIONS

This application claims priority to and the benefit under 35 U.S.C. §119(e) of U.S. Provisional patent application No. 61/675,815 filed Jul. 26, 2012 entitled “Computer System for Private and Secure Collection/Management of Personal Consumer Data aka The Computerized Private Data Concierge,” the disclosure of which is hereby incorporated by reference in its entirety.

### FIELD

Embodiments of this invention relate, generally, to consumer data in computing systems, and in particular, to computing systems which manage and protect consumer data and increase the accuracy of consumer purchasing alternatives.

### BACKGROUND

There are numerous individual computing and software systems that collect data about each consumer (also interchangeably referred to herein as a customer, buyer, prospective buyer, user or the like) of the computing systems. For example, a search engine running in a browser of the computer tracks some or all of the user's various searches and activity on the internet. If a user visits an e-commerce website, a cookie may be created which relates to the user's activity on that particular e-commerce website. As another example, a user may opt in to a hotel rewards program which tracks the user's historical purchases of hotel rooms, locations, services, as well as user profile information which the user expressly provides when establishing their hotel rewards account. As another example, a user's social network account (such as Facebook) maintains large amounts of data including the user's background and preferences (such as “likes” or “dislikes”) of products and services as well as online activities on the social networking site and affiliated sites. As recognized by the present inventors, for a consumer, there may be hundreds of different collections of personal consumer data that are stored in and by hundreds of different websites, companies, entities, and computing devices.

However, as recognized by the present inventors, each conventional system (i) maintains a partial view of the consumer based on the consumer's interaction with that particular conventional system, (ii) collects information about the consumer in a manner over which the consumer has little, if any, control, and (iii) makes use of collected consumer information in a manner over which the consumer has little, if any, control. In other words, (i) the data relating to the consumer that is maintained by a conventional system or social networking site is not necessarily shared with a company running the hotel rewards program and a company collecting the consumer's search engine data, (ii) the information collection generally occurs without the consumer's conscious knowledge and often without the consumer's explicit permission, and (iii) the collected information is often retained and used to the financial benefit of third parties other then the consumer without the consumer's conscious knowledge and often without the consumer's explicit permission.

A February 2013 Business Week article highlighted the need for more effective means of protecting privacy and confidentiality of consumer information:
“Last year a Pew Research Center survey found that 57 percent of all app users “have either uninstalled an app over concerns about having to share their personal information, or declined to install an app in the first place for similar reasons.” A January 2013 study by the Ponemon Institute, a research organization focused on privacy and security issues, found social media to be among the least trusted industries when it comes to protecting customers' privacy online.
Amid the heightened anxiety, many consumers young and old say they're ready for the government to intervene. In a 2010 survey, researchers at the University of California at Berkeley found that although young Americans are often portrayed as having a devil-may-care attitude toward social media, they're as anxious as their parents about their permanent social records. Some 88 percent of participants from ages 18 to 24 responded that there should be a law requiring websites and advertising companies to delete all stored information about an individual upon request. The survey found that 94 percent of people from 45 to 54 also supported the idea.”
   Gillette, Felix. “Snapchat and the Erasable Future of Social Media” Business Week, 7 Feb. 2013, available at http://www.businessweek.com/articles/2013-02-07/snapchat-and-the-erasable-future-of-social-media. Concern over the confidentiality of consumer information is not limited to the United States. In a February 2013 New York Times article, Viviane Reding—the Vice President of the European Commission and the Justice Commissioner of the European Union, noted that:
“The main problem is that our rules predate the digital age and it became increasingly clear in recent years that they needed an update. Seventy-two percent of Europeans have told us in surveys that they are concerned about how companies use their personal data. They are especially worried about online privacy and this is one of the most frequent reasons why people don't buy goods and services online.
People's trust in using digital services depends on whether they know that their data will be safely protected . . . .”
   “Q. and A. With Viviane Reding” New York Times, 2 Feb. 2013, available at http://www.nytimes.com/2013/02/03/business/q-and-a-with-viviane-reding.html?_r=0.

Moreover, as recognized by the present inventors, conventional systems and conventional websites typically do not provide a means by which a consumer/user can review or edit the information maintained by the systems/websites about the consumer.

As recognized by the present inventors, what is needed are systems and methods for private and secure collection and management of a user's personal consumer data.

### SUMMARY

According to one broad aspect of an embodiment of the present invention, methods and systems are disclosed herein for a private data concierge (PDC) that privately and securely collects information about users and selectively discloses such information to third-parties under the control of the user. In one example of the invention, a computer-implemented method for collecting information includes collecting a plurality of data relating to a user from a plurality of unaffiliated data sources, wherein the data comprises data of varying formats. In particular, the collecting at one or more of the plurality of unaffiliated data sources is performed in part under authorization by the user. Also, at least one data source is unaffiliated with another unaffiliated data source such that data is not otherwise shared between those unaffiliated data sources. The method includes aggregating the data collected from the plurality of unaffiliated data sources. The method may also include normalizing the data that is collected and aggregated into a standardized form. The method also includes generating an aggregated data profile associated with the user based on the data that is collected and aggregated. The aggregated data profile includes information relating to characteristics and/or activities of the user.

In this manner, the aggregated data profile contains significant amounts of information about the user gathered from numerous data sources, which helps form a more comprehensive view of the user and their interests and characteristics.

The user can revise or edit one or more items of the aggregated data profile, and the user can control disclosure of one more items of the user's aggregated data profile, for instance to explore possible transactions with vendors on an anonymous basis or with limited disclosure of identifying information. Vendors can be provided with access to portions of user's aggregated data profiles, without disclosing identities or other private information of the users, so that vendors can have access to highly qualified leads of prospective customers.

According to another broad aspect of another embodiment of the present invention, another computer-implemented method for collecting information is disclosed herein. In one example, the method includes collecting a plurality of data comprising online and offline activities of a user from a plurality of unaffiliated data sources, wherein the data comprises disparate data of varying formats. Collection of information at one or more of the plurality of unaffiliated data sources is performed in part under authorization by the user. At least one data source is unaffiliated with another unaffiliated data source such that data is not otherwise shared cooperatively between those unaffiliated data sources. The method includes aggregating the data collected from the plurality of unaffiliated data sources. The method includes normalizing the data that is collected and aggregated into a standardized form. The method includes generating an aggregated data profile associated with the user based on the data that is collected and aggregated. The aggregated data profile includes information relating to characteristics and/or activities of the user. The method includes controlling release of one or more items of data of the aggregated data profile to one or more third parties under authorization of the user.

In this manner, the user can control the release of portions of the aggregated data profiles to third-parties such a vendors, which gives the user control over private user information.

According to another broad aspect of another embodiment of the present invention, a system for collecting information is disclosed. The system includes an online platform configured to generate a plurality of aggregated data profiles for a plurality of users. The system includes a collecting component configured for collecting a plurality of data relating to a user from a plurality of unaffiliated data sources, wherein the data includes disparate data of varying formats. The collecting component performs the collecting at one or more of the plurality of unaffiliated data sources in part under authorization by the user. At least one data source is unaffiliated with another data source such that data is not otherwise shared between those data sources. The system includes an aggregation component for aggregating the data collected from the plurality of unaffiliated data sources. The system may also include a normalizing component for normalizing the data that is collected and aggregated into a standardized form. The system also includes a user profile generator for generating an aggregated data profile associated with the user based on the data that is collected and aggregated. The aggregated data profile includes information relating to characteristics and/or activities of the user.

In this manner, the aggregated data profile contains significant amounts of information about the user gathered from numerous data sources, which helps form a comprehensive view of the user and their interests and characteristics.

According to another broad aspect of another embodiment of the present invention, disclosed herein is a computer system, comprising a module providing for collecting, from a plurality of data sources, one or more items of personal consumer data related to a user; a module providing for securely storing, in one or more databases, the one or more items of personal consumer data related to a user to form an aggregated data profile of the user; and a module providing controls for the user to revise at least one of the items of personal consumer data in the user's aggregated data profile. In one example, the plurality of data sources includes one or more social networking sites, internet search engines, credit card accounts of the user, or other data sources as described herein.

In one example, the aggregated data profile includes at least one interest in a product or service as derived from the one or more items of personal consumer data collected from the plurality of data sources.

In one example, the module providing controls for the user to revise at least one of the items of personal consumer data in the user's aggregated data profile, includes a graphical user interface that selectively displays the at least one of the items of personal consumer data. The controls may include controls for the user to confirm, delete or modify at least one of the items of personal consumer data.

In another embodiment of the invention, the computer system may also include a module for anonymously identifying users to vendors wherein the users match one or more queries from one or more vendors and wherein the identification is based on the contents of the user's aggregated data profile.

In another embodiment of the invention, the computer system may also include a module for identifying vendors to one or more users, wherein such vendors match one or more requests for product information from the users.

In another embodiment of the invention, the computer system may also include a module for recommending to one or more users one or more products for purchase, wherein the recommending is based in part on the contents of the user's aggregated data profile.

In another embodiment of the invention, the computer system may also include a module for recommending to one or more users one or more other users, wherein the recommending is based in part on the contents of the user's aggregated data profile.

In another embodiment of the invention, the computer system may also include a module for providing users that have authority over other users with the ability to control the activities of subordinate users, wherein the control is based in part on activities that the authority user designates in advance as being approved and/or permissible.

The features, utilities and advantages of various embodiments of the invention will be apparent from the following more particular description of embodiments of the invention as illustrated in the accompanying drawings.

### BRIEF DESCRIPTION OF THE DRAWINGS

FIG. 1 is a diagram 100 illustrating the information collected and aggregated by a private data concierge (PDC) that relate to characteristics of a consumer or user, in accordance with one embodiment of the present disclosure.

FIG. 2 is a diagram of an Anonosphere™ 200 including a combination of otherwise independent silos of information relating to online and offline activities of a particular user, in accordance with one embodiment of the present disclosure.

FIG. 3 illustrates an example of a block diagram of a system including a PDC, in accordance with one embodiment of the present invention.

FIG. 4 illustrates another example of a block diagram of a system including a PDC, in accordance with one embodiment of the present invention.

FIGS. 5A-B are diagrams which combined illustrate the collection of information of a particular user from unaffiliated data sources, which otherwise would not be configured to share information, in accordance with one embodiment of the present invention.

FIG. 6 illustrates an example of data fields in an aggregated data profile of a consumer that may be maintained by the PDC, in accordance with one embodiment of the present invention.

FIG. 7 illustrates an example of a process for aggregating personal consumer data from disparate sources regarding a user to create a secure aggregated data profile, in accordance with one embodiment of the present invention.

FIG. 8 illustrates an example of a process for enabling user modifications to the user's secure aggregated data profile, in accordance with one embodiment of the present invention.

FIG. 9 illustrates a process for recommending products or services to a user based on the user's aggregated data profile, in accordance with one embodiment of the present invention.

FIG. 10 illustrates an example of a process for alerting a vendor of the existence of one or more qualified prospective buyers, in accordance with one embodiment of the present invention.

FIG. 11 illustrates an example of a process for alerting a vendor of a qualified prospective buyer based on the user's request, in accordance with one embodiment of the present invention.

FIG. 12 illustrates a process for recommending products or services to a user based on comparing products or services selected by other users who have data profiles similar to the user's aggregated data profile, in accordance with one embodiment of the present invention.

FIG. 13 illustrates an example of a process for enabling a vendor to question one or more qualified prospective buyers as to what features and functions they would prefer to see in new product/service offerings, in accordance with one embodiment of the present invention.

FIG. 14 illustrates a process for recommending potential friends or dates to a user based on a user's aggregated data profile, in accordance with one embodiment of the present invention.

FIG. 15 illustrates an example of a computer display screen having a graphical user interface that can be implemented by the PDC, showing one or more controls provided for a user to manage and use their aggregated data profile, in accordance with one embodiment of the present invention.

FIG. 16 illustrates an another example of a computer display screen having a graphical user interface that can be implemented by the PDC, showing one or more controls provided for a user to manage and use their aggregated data profile, in accordance with one embodiment of the present invention.

FIG. 17 illustrates another example of a computer display screen having a graphical user interface that can be implemented by the PDC, showing one or more controls provided for a user to manage inclusion and exclusion of disparate date sources with the user's aggregated data profile, in accordance with one embodiment of the present invention.

FIG. 18 illustrates another example of a computer display screen having a graphical user interface that can be implemented by the PDC, showing one or more controls provided for a user to manage specific data fields of the user's aggregated data profile, in accordance with one embodiment of the present invention.

FIG. 19 illustrates another example of a computer display screen having a graphical user interface that can be implemented by the PDC, showing one or more controls provided for a user to review and manage categories of information of the user's aggregated data profile, in accordance with one embodiment of the present invention.

FIG. 20 illustrates another example of a computer display screen having a graphical user interface that can be implemented by the PDC, showing one or more controls provided for a user to review and manage categories of information of the user's aggregated data profile, in accordance with one embodiment of the present invention.

FIG. 21 illustrates another example of a computer display screen having a graphical user interface that can be implemented by the PDC, showing one or more controls provided for a user to review and manage information of the user's aggregated data profile as reported by disparate data sources, in accordance with one embodiment of the present invention.

FIG. 22 illustrates another example of a computer display screen having a graphical user interface that can be implemented by the PDC, showing one or more controls provided for a user to review, manage and specify further detail regarding information in the user's aggregated data profile, in accordance with one embodiment of the present invention.

FIG. 23 illustrates another example of a computer display screen having a graphical user interface that can be implemented by the PDC, showing one or more controls provided for a user to request information from vendors relating to specific categories, in accordance with one embodiment of the present invention.

FIG. 24 illustrates another example of a computer display screen having a graphical user interface that can be implemented by the PDC, showing one or more controls provided for a user to request information from vendors relating to products, in accordance with one embodiment of the present invention.

FIG. 25 illustrates another example of a computer display screen having a graphical user interface that can be implemented by the PDC, showing one or more controls provided for a user to specify the amount of information for the PDC to release to vendors about the user, in accordance with one embodiment of the present invention.

FIG. 26 illustrates another example of a computer display screen having a graphical user interface that can be implemented by the PDC, showing one or more controls provided for a user to review and approve the disclosure by the PDC of a message to one or more vendors about the user, in accordance with one embodiment of the present invention.

FIG. 27 illustrates another example of a computer display screen having a graphical user interface that can be implemented by the PDC, showing one or more controls provided for a user to review and approve the disclosure by the PDC of another message to one or more vendors about the user, in accordance with one embodiment of the present invention.

FIG. 28 illustrates another example of a computer display screen having a graphical user interface that can be implemented by the PDC, showing one or more controls provided for a user to review and select possible offers from vendors of products, in accordance with one embodiment of the present invention.

FIG. 29 illustrates another example of a computer display screen having a graphical user interface that can be implemented by the PDC, showing one or more controls provided for a user to interact with a vendor to with respect to offers from the vendor, in accordance with one embodiment of the present invention.

### DETAILED DESCRIPTION

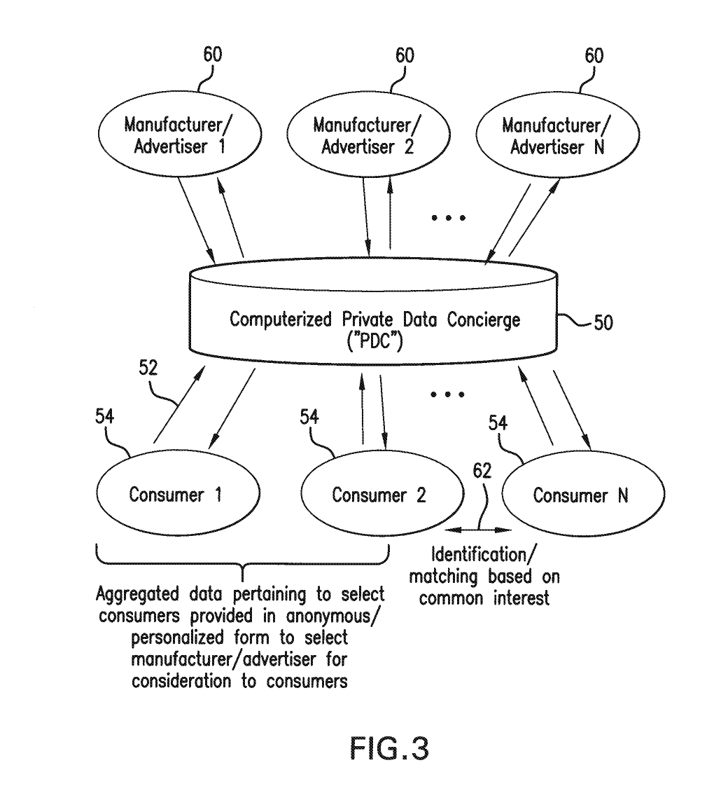

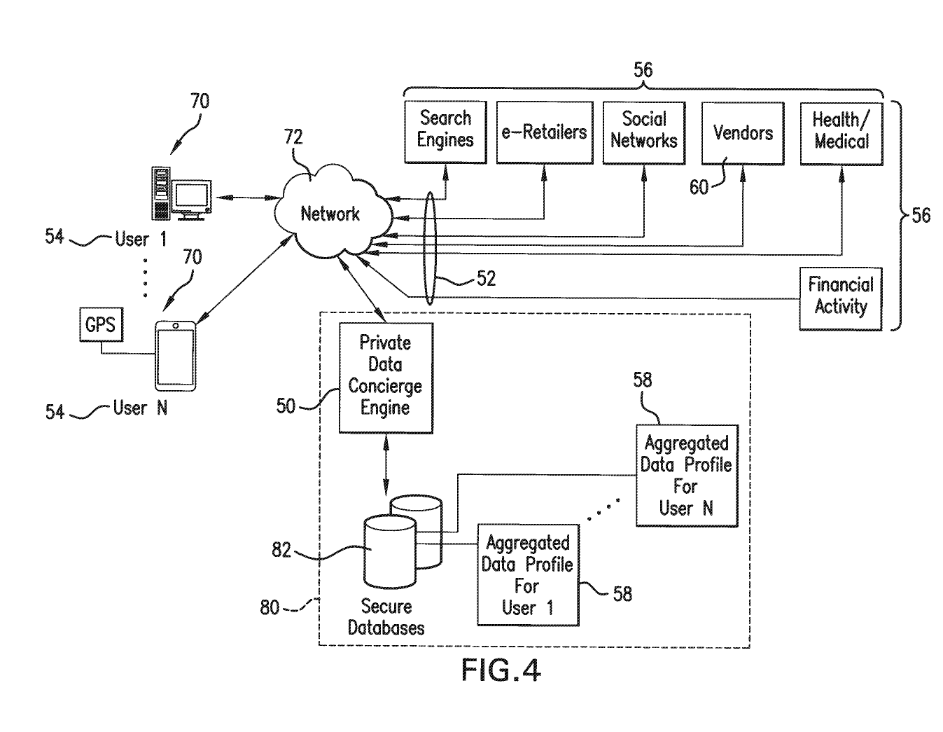

Disclosed herein are various systems and methods for private and secure collection and management of a user's personal consumer data. As described herein, various embodiments of the invention include a private data concierge (PDC) 50 (see FIGS. 3-4) which securely aggregates various items of data and information 52 (referred interchangeably herein as personal consumer data, which may include but is not limited to behavioral data, transaction histories, credit ratings, identity information, social network data, personal history information, employment information, education history) relating to a user 54 collected from and associated with numerous disparate data sources 56 (such as but not limited to social networks, search engines, financial entities, e-commerce websites, vendor websites, and portable devices like smart phones and tablet computers).

Embodiments of the invention form a secure and comprehensive aggregated data profile 58 of a user 54 by collecting information related to the user from across various disparate data sources 56; and once the aggregated data profile 58 of the user is securely formed, embodiments of the present invention permit the user to either anonymously communicate with or selectively disclose the user's identity and/or the user's aggregated data profile 56 (or portions thereof) to vendors, advertisers or other entities 60 that are interested in communicating with the user 54 (for instance, to possibly enter into a purchase transaction) based on one or more of the user's characteristics as expressed in the user's aggregated data profile 58. In this manner, embodiments of the invention provide for forming a more complete and accurate profile of a consumer/user in a secure manner that is controlled by the user, thereby providing the user with improved control over the user's personal consumer data and privacy.

Additionally, embodiments of the invention provide for facilitating interactions and communications 62 (FIG. 3) between users 54 and vendors/advertisers/manufacturers/retailers 60 in an anonymous manner if desired—and in this way embodiments of the present invention can provide highly qualified anonymous leads of potential customers 54 to vendors/advertisers/manufacturers/retailers 60 of products and/or services. In addition, embodiments of the invention provide for facilitating interactions and communications among users in an anonymous or non-anonymous manner as desired—and in this way embodiments of the present invention can provide highly qualified introductions to potential friends, dates and like-minded individuals with whom users can communicate and interact.

In one embodiment, a PDC 50 is configured to collect and use information 52 related to a user 54. The operations performed by one example of the PDC are described in Equations 1 and 2, below. More specifically, the first part of Equation 1 relates to the input of information into the PDC. Specifically, the collection of information by the PDC is controlled by the user, and is expressed as “User Control” (UC). Further, the collection of information is performed over multiple “Unaffiliated Data Systems” (UDS), numbered 1-N. The second part of Equation 1 relates to the output of information from the PDC. Uniquely, the output of information by the PDC is also controlled by the user, as expressed by the reuse of the term “User Control” (UC). That is, the user controls access to and use of PDC information collected by multiple “Authorized Third Parties or Vendors” (ATPs). Equation 1 is defined, as follows:

PDC=(UC×UDS1−n)+(UC×ATP1−n) (1)

As recognized by the present inventors, most data collection services focus on information related to “online” activities. In embodiments of the present invention, the PDC 50 is configured to include both information relating to online activities (“OLA”) as well as information related to offline activities (“OFA”), as is expressed in Equation 2, as follows:

PDC=OLA+OFA (2)

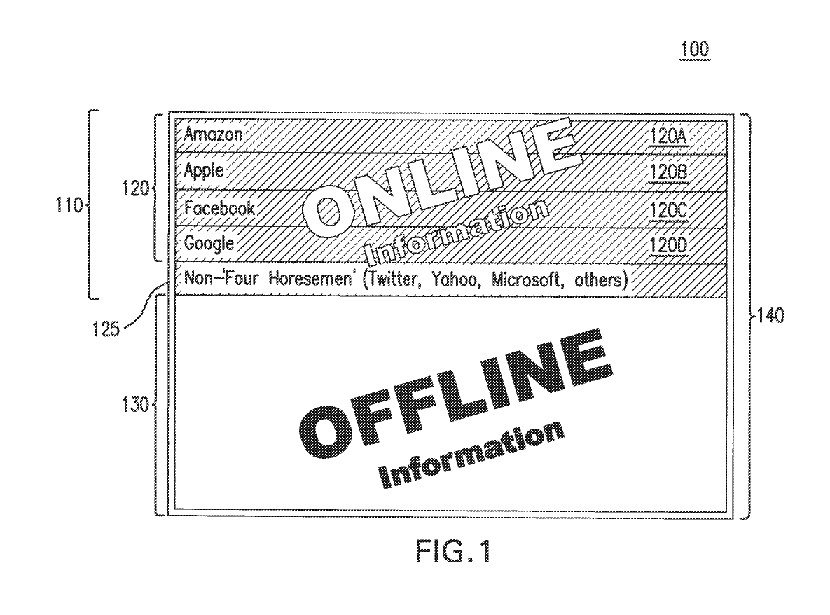

More particularly, FIG. 1 is a diagram 100 illustrating the information that can be collected and aggregated by a PDC 50 that relate to characteristics of a consumer or user 54, in accordance with one embodiment of the present disclosure. As shown, in one example of the invention, the PDC collects online information 110 and offline information 130 within the combination 140. The online information 110 and offline information 130 are used for purposes of generating an aggregated user profile 58 that is associated with the user 54. As expressed in Equation 2 and shown in FIG. 1, the PDC is able to collect and distribute information relating to both offline and online activities of a particular user, in accordance with embodiments of the present disclosure.

For purposes of the present application, the term “online” activity refers to activity that occurs while connected to a computer or telecommunications network, such as, the internet as compared to “offline” activity which refers to activity that occurs in the real (or physical) world; it should be noted that information with regard to both online and offline activity may be captured, collected, reported, etc. via electronic or telecommunications mechanisms—the difference between the terms pertains to whether the underlying activity in question occurs online or in the real (or physical) world.

Google chairman, Eric Schmidt, has expressed his opinion that there are “Four Horsemen” 120 driving the consumer revolution on the internet—Amazon, Apple, Facebook and Google. Chiang, Lulu. “Google's Schmidt Remembers Steve Jobs.” CNBC, 6 Oct. 2011, available at http://www.cnbc.com/id/44808266/Googlersquos_Schmidt_Remembers_Steve_Jobs. Information collected by each of the Four Horsemen 120 is shown in FIG. 1 as four independent silos of information 120A-D, such that information is not cooperatively shared between each of the silos. For instance, the proprietary information about the user that is collected by Amazon is shown in independent silo 120A, the proprietary information collected by Apple is shown in independent silo 120B, the proprietary information collected by Facebook is shown in independent silo 120C, and the proprietary information collected by Google is shown in independent silo 120D. Other entities such as Twitter, Yahoo, Microsoft and others (collectively, “Others”) also exert influence on the internet consumer revolution. The information from these Others is shown in block 125 for illustration purposes only, as the information collected by each Other entity is also used only by that entity, and not cooperatively shared with unaffiliated entities. That is, the information collected by each Other entity is collected and stored in its own corresponding silo within block 125.

Each of these Four Horsemen 120 and Others 125 influence the internet consumer revolution by controlling one or more of four key online platforms: 1) Mobile Operating System; 2) Mobile Hardware; 3) Internet Browser; and/or 4) Social Media. However, each of these Four Horsemen and Others control only that “Online Information” (OLI) processed by those platforms over which they exercise influence and/or control.

Further, each of the Four Horsemen fail to effectively incorporate consumer information from non-online sources of “Offline Information” (OFI). Offline information is related to offline activities of a user, and may be facilitated through some online activity, or defined in combination with online activity. For instance, the user may perform online research regarding an automobile purchase, and perform offline activity when actually purchasing the automobile through a dealership.

Other examples of offline activities include grocery shopping, wherein the purchases made by a user at a grocery store are offline activities; and to the extent that the grocery store tracks or maintains data relating to what the user purchased, for instance through a rewards or loyalty card, such data related to the user's offline activities and purchases can be communicated to or obtained by the PDC to form part of the user's aggregated data profile. Other examples of offline activity may include, but are not limited to, exercises performed by a user and tracked via the user's smartphone; travel conducted by the user and tracked by the user's airline, hotel and car rental loyalty accounts. These are but a few possible user offline activities where data related to the user's offline activities can be obtained by the PDC for inclusion in the user's aggregated data profile.

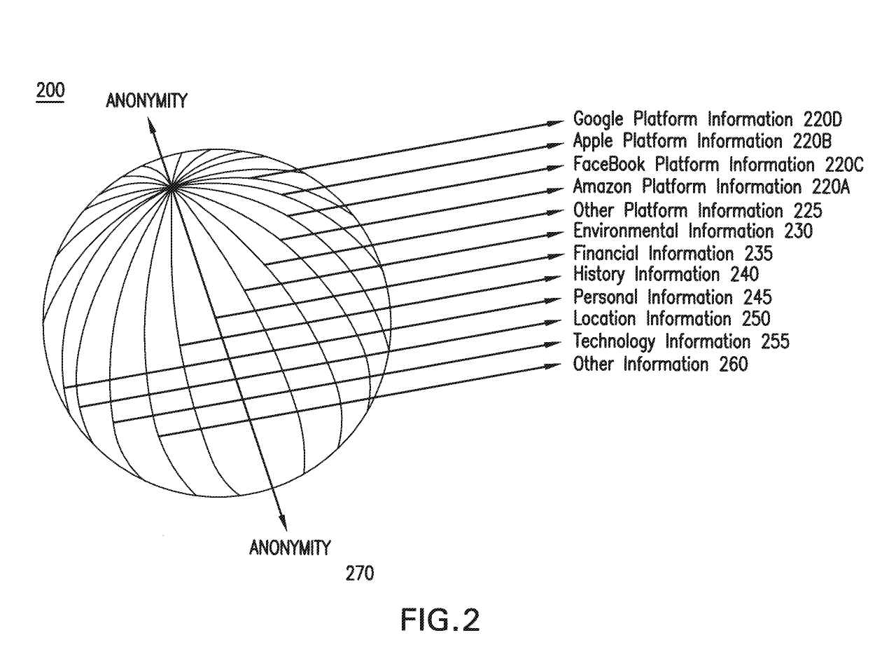

FIG. 2 is a diagram of an Anonosphere™ 200 including a combination of otherwise independent silos of information or data sources 56 relating to online and offline activities of a particular user 54, in accordance with one embodiment of the present disclosure. The anonosphere 200 is analogous to an aggregated data profile 58 corresponding to the user as provided by an embodiment of the present invention. As shown, the anonosphere 200 includes a plurality of slices, wherein each slice contains information (e.g., data and information 52) relating to a user as collected by a particular platform associated with the user. For example, slice 220A includes information collected by the Amazon Platform, such as, information in silo 120A; slice 220B includes information collected by the Apple Platform, such as, information in silo 120B; slice 220C includes information collected by the Facebook Platform, such as, information in silo 120C; and slice 220D includes information collected by the Google Platform, such as, information in silo 120D of FIG. 1. Additional information related to the user is included in other slices that may be defined as online, offline, or in combination, such as, environmental information in slice 230; financial information in slice 235, history information in slice 240, personal information in slice 245, location information in slice 250, technology information in slice 255, and other information in slice 260.

One uniqueness of the anonosphere 200 is that information that otherwise would be separate and independent of each other is collected and aggregated into one anonosphere 200 for a particular user 54. As such, the collected and derived information included within anonosphere 200 is more complete than any profile associated with any of the Four Horseman 120 or other entities 125.

Additionally, in accordance with one aspect of the present invention, the information contained within the anonosphere 200 is anonymous to entities 60 outside of the PDC 50. In one embodiment of the present invention, information is selectably released through authorization of the user, such that the user is able to specify which information or types of information is released, and to what degree. In that manner, information is released with degrees of security, will be described in more detail below. As such, the user is able to operate around an axis 270 of anonymity, wherein the anonymity is controlled by the user.

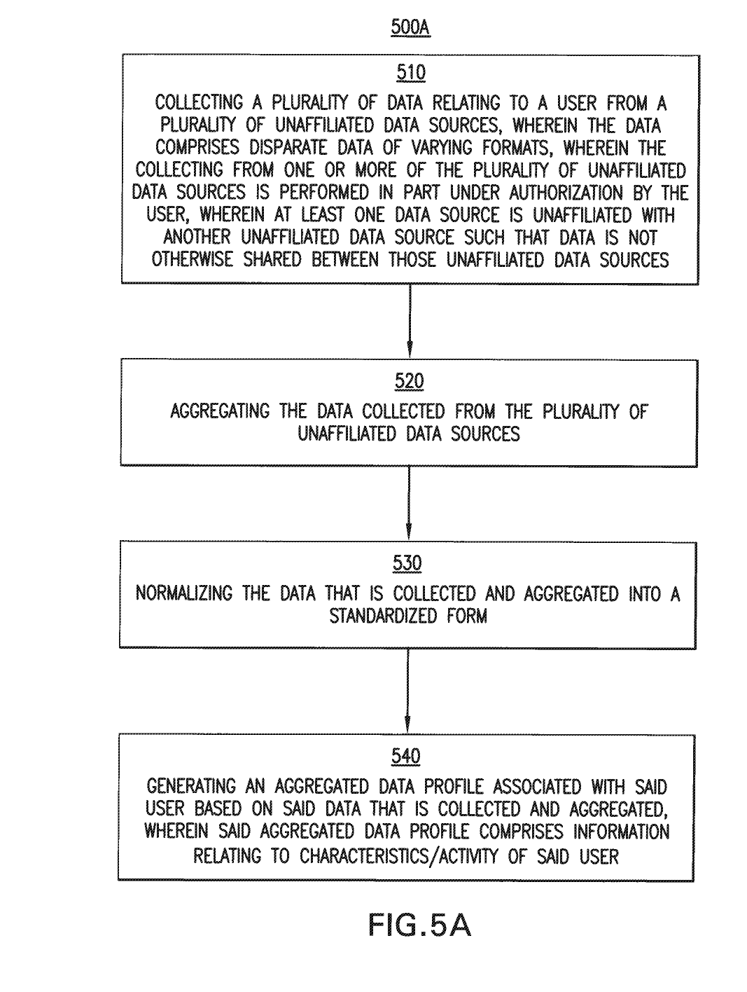

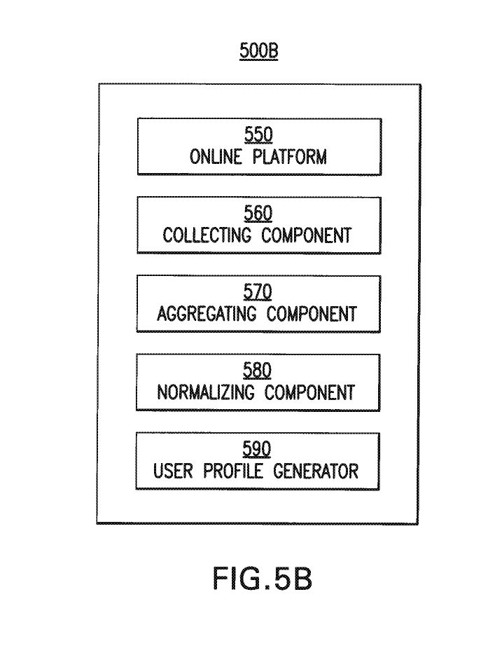

FIGS. 3-4 illustrate examples of block diagrams of systems including a PDC 50, in accordance with one embodiment of the present invention. A computerized PDC (also described herein as a PDC engine) 50 may be implemented in a computing system as computer program modules, code products, or modules running on a server or other computing device; and may be in communication with one or more manufacturers/advertisers 60 and may also be in communication with one or more consumers or users 54. As described herein, the PDC 50 gathers personal consumer data and information 52 about a user 54 from a variety of different data sources 56 and aggregates that data to form a secure aggregated data profile 58 of the user 54. In one example, the PDC 50 can notify one or more manufacturers/advertisers 60 of the existence, on an anonymous basis, of one or more users that may be of interest to the manufacture/advertiser regarding the potential purchase and sale of products and services. As used herein, the terms private data concierge, personal data concierge, PDC, PDC 50 (FIGS. 3-4), PDC 500B (FIG. 5B), and the like, are used interchangeably such that one or more features or aspects of PDCs described herein may be implemented variously as desired depending upon the particular implementations.

If desired, the PDC 50 can receive and categorize information regarding product and service offerings from manufacturers/advertisers 60. In one example, the PDC examines and compares interests of the users/consumers 54 (as contained in the user's aggregated data profile 58) with the offerings of the manufacturers/advertisers, and the PDC notifies the manufacturer/advertisers 60 of the existence of a perspective buyer on an anonymous basis. For instance, a consumer interested in a category of product or service offerings can be anonymously communicated by the PDC 50 to the relevant manufacturer/advertisers 60 to determine whether there is a match between consumer defined criteria and the manufacturer/advertisers. When a match is determined, limited information necessary to initiate a transaction may be exchanged with the user's consent between the consumer and the manufacturer, and if desired by the user, additional identifying information about the user may also be provided to the manufacturer/advertiser.

In another example, the PDC 50 examines the consumer interests and behavior data in the user's aggregated data profile 58, and the PDC suggests or recommends products/services to the user 54 without identifying the consumer to the manufacturers and advertisers 60. In this way, recommendations are made to the user 54 without the disclosure of the user's identity which thereby enhances the privacy of the user and can reduce or prevent the creation of unwanted e-mails or other unwanted communications from manufacturers/advertisers to the user. Also, the aggregation of data 58 from multiple unaffiliated data sources 56 related to the consumer's preferences/activities increases the accuracy of recommendations made by the PDC or by vendors to the consumer based on their aggregated profile 58 information.

In the example of FIG. 4, a plurality of users 54 utilize devices 70 such as mobile phones, smart phones, personal computers, tablet computers, smart TVs, or other computing devices to access a network 72 such as the internet. The user's computing devices may include GPS or other locational information. In the normal course of using the internet, the user accesses and utilizes a plurality of websites or services offered over the internet, including search engines, and websites of e-commerce retailers, social networks, websites of product or service vendors, health or medical services, financial services such as online banks or credit cards, or any conventional product or service offered over the internet.

As shown in FIG. 4, a system 80 is illustrated which is coupled with and in communication with the internet 72, and includes a PDC engine 50 securely coupled with a plurality of databases 82. The PDC engine 50 may be implemented using computer program modules, code products, or modules running on a server or other computing device. The plurality of databases 82 may be implemented using any conventional database technology, including technology that securely stores data (such as through encryption) in redundant locations such as but not limited to RAID storage devices, network attached storage, or any other conventional databases.

The PDC engine 50 implements one or more of the operations, processes, or process steps as described herein, and may include other operations or process steps as desired depending upon the particular implementation. The PDC engine 50 gathers information 52 (such as 120, 125 and/or 130 shown in FIG. 1) from a variety of both online and offline disparate data sources 56 (such as, from search engines, E retailers, social networks, financial entities, digital media streaming services, user input, etc. for example, as shown in FIGS. 1-2) about a user and aggregates that information into an aggregated data profile 58 regarding the user 54.

There are a variety of different types of consumer information and data 52 including but not limited to the following: structured, unstructured, big, behavioral (implicit), individual (explicit), derived, personal identifying information (PII), as well as other types of data suitable for collection and classification or as described herein.

Structured data includes data that has an enforced composition of data types and/or layouts with a predetermined relationship one to another, such as, those associated with a user or participant. For example, in a particular registration form, the first field is used to identify the name of the participant, the second field is used for age, the third field is used for address, etc.

Unstructured Data includes data stored in an unstructured format with no conceptual definition or data type definition—e.g., in textual documents, a word is simply a word.

Further, Frank Moss describes “Big Data” in his article entitled “How Small Businesses Are Innovating With ‘Big Data’Business.” Moss, Frank. “How Small Businesses Are Innovating With ‘Big Data’.” MSN—Business On Main, available at http://businessonmain.msn.com/browseresources/articles/inventingan dnewideas.aspx?cp-documentid=30009963#fbid=rMM72SDnRvP. Specifically, “Big Data” is defined as “ . . . the explosion of structured and unstructured data about people—you, me and everyone . . . . Computers, smart phones, GPS devices, embedded microprocessors, sensors—all connected by the mobile internet—are forming a ‘societal nervous system’ that is generating a cloud of data about people that is growing at an exponential rate . . . . Every time we perform a search, tweet, send an email, post a blog, comment on one, use a cell phone, shop online, update our profile on a social networking site, use a credit card, or even go to the gym, we leave behind a mountain of data, a digital footprint, that provides a treasure trove of information about our lifestyles, financial activities, health habits, social interactions, and much more . . . . For decades, public and private institutions have been storing data about individuals through employee records, customer transactions and electronic medical records . . . . But it's been accelerated by the spectacular success of social networks like Facebook, Twitter, Foursquare and LinkedIn, and video/picture sharing services like YouTube and Flickr. When acting together, these services generate exponential rates of growth of data about people in astonishingly short periods of time . . . . Once the stuff of sci-fi, it's now possible to use mobile phones and wireless sensors to collect huge volumes of data about people's emotions ‘in the wild’—where they live, work and play. These data sets reveal important patterns that can revolutionize how consumer products are conceived, designed and marketed.”

Behavioral or implicit data includes data gathered by tracking a consumer's activity. For example, behavioral data may be gained from tracking a user's everyday actions on a retailer's website.

Individual or explicit data includes data expressly provided by a consumer. For example, explicit data is collected by means of completing registration forms, surveys, quizzes, etc.

Derived Data includes data derived from other information using a mathematical, logical, or other type of transformation—e.g., arithmetic formula, composition, aggregation. Generally, original data used to determine derived data cannot be reconstituted from the derived data—e.g., a credit score for a consumer.

Personal Identifying Information (PII) includes information that reveals facts about a person. As an example, PII forms a basis to determine the identity of the person. Various forms of PII include, but are not limited to, social security number, bank account number, etc.

All of these various types of data may be collected by the PDC 50 both in online and offline environments, as further described below depending upon the particular implementation. In brief, in an online environment, the information may be pulled both by third party vendors and the PDC in the sense that the user's activities are collected. Also, information may be pushed to those third party vendors, and/or the PDC, such as, when the user actively provides information. In an offline environment, information is pushed to or pulled by the PDC, such as various activities performed by a user is related to the PDC or requested by the PDC.

For example, consumer data and information can be gathered by the PDC 50 in a variety of manners including, but not limited to, direct input by consumers, placing a tracking cookie on the consumer's machine which reports all internet use to the PDC, automatic importing of information from third party systems (i.e., 56) with which the consumer interacts with the explicit permission of the consumer by means of delivery of the information by such third parties to the PDC, signing on to third party systems using credentials provided by the consumer such as user ID and password to extract desired information, or population by third party data providers such as Axiom. Desirable information about the user 54 includes, but is not limited to, searches conducted, products purchased, posts to social networks, browsing activity on visited sites and purchasing activity online and at physical locations.

The PDC engine 50 then makes the aggregated data profile 58 securely available to the respective user 54 so that the user can view, modify and supplement the profile 58 as desired. The PDC engine 50 maintains the aggregated data profile 58 in a secure manner, and, in one example with the explicit permission of the user, uses portions of information contained in the user's aggregated data profile 58 to identify, on an anonymous basis, the existence of a prospective buyer to one or more advertisers/retailers/manufacturers or other entities 60.

In this manner, interested companies 60 can utilize embodiments of the present invention for locating, anonymously, highly qualified leads for the potential purchase and sale of products and services; and this system (i.e., 80) can assist in facilitating communications between the user 54 and such companies 60. In particular, the PDC 50 is able to generate one or more highly qualified leads of PDC users 54 for a particular third party vendor 60 (e.g., in the sale of a product or service), wherein a highly qualified lead is an individual or entity 54 that is associated with attributes that has been historically found to be closely associated with an actual purchaser. By way of example, such communications can include without limitation, providing an anonymous profile (or portions thereof) of an interested user 54 to a vendor 60, alerting a user to potential vendors of interest to the user and enabling the user to communicate with the vendor through the PDC without disclosing any personal information, and others.

FIGS. 5A-B are diagrams which combined illustrate the collection of information of a particular user 54 from unaffiliated data sources 56, which otherwise would not be configured to share information, in embodiments of the present invention. In particular, FIG. 5A is a flow diagram 500A illustrating a method for collecting information relating to a user 54 from unaffiliated data sources 56 (such as those shown and described herein, for instance with reference to FIGS. 1-4), in accordance with one embodiment of the present disclosure. Further, FIG. 5B is an illustration of a PDC 500B that is configured to collect information relating to user 54 from unaffiliated data sources 56 using an online platform 550 that is configured to generate a plurality of data profiles 58 for a plurality of users, in accordance with one embodiment of the present disclosure.

As shown, FIG. 5A is a flow diagram 500A illustrating a computer implemented method for collecting information, in accordance with one embodiment of the present disclosure. Flow diagram 500A can be implemented within a computer system including a processor and memory coupled to the processor and having stored therein instructions that, if executed by the computer system causes the system to execute a method for collecting information. In still another embodiment, instructions for performing a method are stored on a non-transitory computer-readable storage medium having computer-executable instructions for causing a computer system to perform a method for collecting information. The method outlined in flow diagram 500A is implementable by the PDCs of embodiments of the present invention, including PDCs in FIGS. 3, 4, and 5B. In the example of FIG. 5B, a PDC can be implemented in an online platform 550 and may include other components 560, 570, 580, 590. Online platform 550 can include one or more features of a PDC as disclosed herein, and/or may include one or more functions, processes, Graphical User Interfaces, or portions thereof, as described herein.

Specifically, at 510 the method includes collecting a plurality of data relating to a user from a plurality of unaffiliated data sources. The data includes disparate data of varying formats (e.g., structured and unstructured data). The collection of data from one or more of the plurality of unaffiliated data sources is performed in part under authorization by the user. Further, in the plurality of data sources, at least one data source is unaffiliated with another data source, such that data is not otherwise shared between those unaffiliated data sources without benefit of embodiments of the present invention. In one embodiment, the operations performed at 510 are executed by the collecting component 560 of the PDC 500B of FIG. 5B.

Also, at 520 the method includes aggregating the data collected from the plurality of unaffiliated data sources. In this manner, data from one unaffiliated data source is combined and relatable to other data from other unaffiliated data sources. In one embodiment, the operations performed at 520 are executed by the aggregating component 570 of the PDC 500B of FIG. 5B.

At 530, the method includes normalizing the data that is collected and/or aggregated into a standardized form. In that manner, relevant data distilled down to a standardized format is capable of being efficiently analyzed. In one embodiment, the operations performed at 530 are executed by the normalizing component 580 of the PDC 500B of FIG. 5B.

At 540, the method includes generating an aggregated data profile associated with the user based on the data that is collected and aggregated. More specifically, the aggregated data profile includes information relating to characteristics and/or activities of the user. That is, representations of data collected and aggregated are included within the aggregated data profile. In one embodiment, the operations performed at 540 are executed by the user profile generator 590 of the PDC 500B of FIG. 5B.

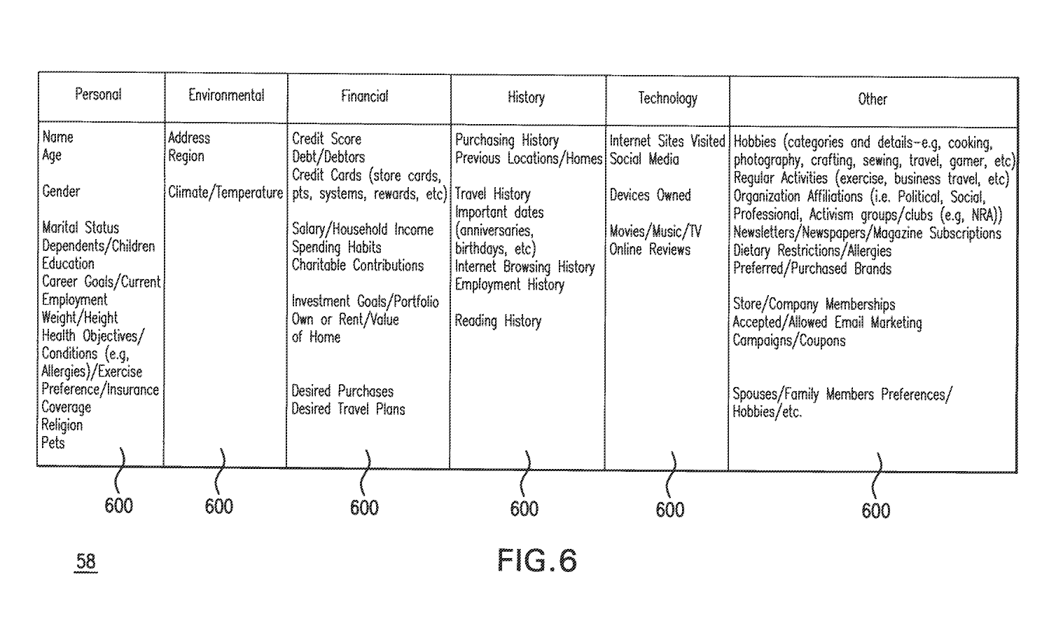

FIG. 6 illustrates an example of data fields in an aggregated data profile (i.e., 58) of a consumer or user which may be maintained by the PDC, in accordance with one embodiment of the present invention. It is understood that FIG. 6 is provided by way of example only, and that aggregated data profiles 58 can be created in accordance with embodiments of the present invention having different data fields, fewer data fields, or more data fields than is illustrated in the example of FIG. 6. In one example, an aggregated data profile of a user as maintained by the PDC of FIGS. 3-5 may include data fields 600 relating to personal information (i.e., name, age, gender, marital status, email address), environmental information (i.e., address, religion, climate/temperature), financial information (i.e., credit score, credit cards, reward cards, income information, spending habits, charitable contributions, value of home, desired purchases, desired travel plans), historical information (i.e., purchasing history, previous homes/locations, birthdays, anniversaries, employment history, internet browsing history), technology information (i.e., internet sites visited, social media accounts, devices owned, movies/music/TV information, online reviews), or other information (i.e., Hobbies, organization affiliations, subscriptions, preferred brands, loyalty or membership program information) including information and data types that are disclosed herein.

As mentioned above, the specific user data to populate data fields 600 of the user's aggregated data profile 58 can be obtained—in real-time or periodically—by the PDC from a plurality of different data sources, such as but not limited to social networks, search engines, financial entities, e-commerce websites, vendor websites, an portable devices like smart phones and tablet computers. The PDC 50 may also request such information directly from the user or provide a graphical user interface so that the user can add/supplement and modify/edit certain of the information contained in the data fields of the user's aggregated data profile.

Embodiments of the present invention can also utilize a unique proxy identifier for each user (e.g., such identifier including alphanumeric text in one example). Such unique proxy identifiers associated with each user provide an additional level of security, whereby the consumer's actual identity is not revealed to an outside party (unless specifically authorized by the consumer) but rather the unique proxy identifier is generated by the PDC and used. In one example, only the PDC knows how to relate back each unique proxy identifier back to the respective user/consumer in the system. If desired, the proxy identifier itself can be changed on a regular basis to provide further protection. For example, on day 1 a user might be associated with a proxy identifier 1234 but the next day a different proxy identifier (e.g., “abcd”) could be assigned, and so forth; with the database(s) of the PDC keeping track of the then current (and past) proxy identifiers associated with each of the users/consumers in question. Hence, embodiments of the invention as described herein may utilize unique proxy identifiers for each user as a way of identifying a user without disclosing their identity.

One of the benefits of embodiments of the present invention relates to the security of information related to users. Consumer information stored by other disparate data sources (i.e., vendors/marketers/websites) is subject to the vagaries and disparate levels of security provided by such parties maintaining the data. By concentrating consumer data within the PDC system as disclosed herein, embodiments of the invention can be adapted to provide the highest levels of data protection and associated certifications (e.g., ISO 27001, SSAE 16/SOC 1, and SOC 2 certifications) and leverage those capabilities to protect each user's aggregated data profile as stored in the database(s) of the PDC system. This structure of data security protection is expected to be more effective than in the alternative case where each of the different data sources/repositories would have to invest separately in data security to get the same benefit.

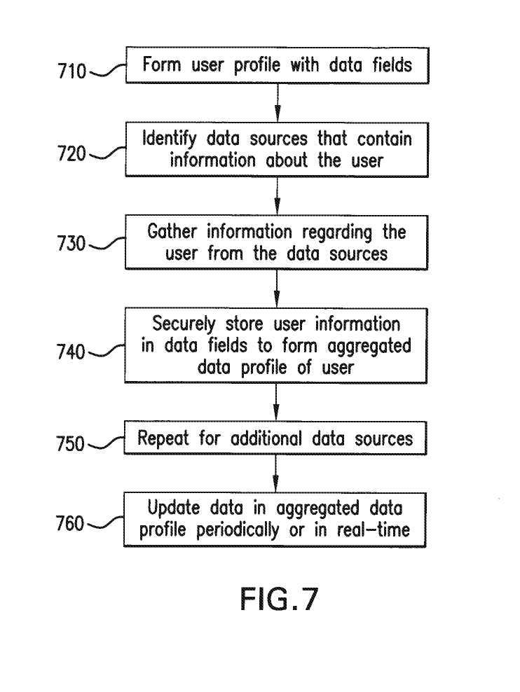

FIG. 7 illustrates an example of a process for aggregating personal consumer data from disparate sources regarding a user to create a secure aggregated data profile, in accordance with one embodiment of the present invention. At operation 710, a user profile is formed with a plurality of data fields. For instance, a template such as shown in FIG. 6 is created and associated with a particular user. At operation 720, the consumer identifies various data sources that contain user information and registers or logs each of these data sources with the PDC; the PDC in turn assigns to each data source an anonymous identifier that is associated with the consumer's use of that data source, in one example.

In one example, the PDC is in communication with a defined set of data sources such as search engines, e-commerce retailers, social networks, vendors, financial service entities, or other entities, databases, websites. At operation 730, the information maintained by the data sources identified in operation 720 related to the user is transferred via one of numerous conventional means of data transfer such as via terminal emulation (Telnet), File Transfer Protocol (FTP), SSH (Secure SHell) or Secure CoPy (SCP) by appropriate means given time sensitivity of the data and associated cost considerations such as via “stream mode” where data is sent in a continuous stream, “block mode” where the data is segregated into logical blocks or “compressed mode” where data is compressed before sending using an algorithm that is then used following receipt to decrypt the data. Desired data may exist in a predictable “structured” format that can be transferred by any of the aforementioned manners or, if unstructured, can be converted into a specified format prior to, or after, submission to the PDC so as to reside in the PDC in an expected, predictable, normalized format.

The collection of information from unaffiliated data sources includes proprietary information derived and/or collected by one or more unaffiliated data sources. This proprietary information may be defined in varying degrees of security and privacy, in relation to the holding third party vendor. For instance, a level 1 proprietary information may include relatively public information related to a user, such as, information provided on a social media website associated with the user. That information may be collected through direct access to that website, and with authorization by the user. Lower levels of proprietary information includes derived data, such as, behavioral statistics, or information that is derived from user activity, behavioral statistics, etc. When the user owns that information, user authorization allows the PDC to gain access to that information.

However, when the third party vendor owns that information, collection of that information is achieved through authorization by that third party vendor. A third party vendor authorizes the delivery of information to the PDC because it benefits the third party vendor. That is, the PDC is able to aggregate proprietary information from one or more unaffiliated data sources, in order to generate a more complete and accurate aggregated data profile of that PDC user. In one embodiment, the proprietary information is secure within the PDC environment, and not released to other third party vendors. The information and targeting of the user using the PDC aggregated data profile is used by the PDC to provide qualified leads that are of higher quality than those produced by any one of the unaffiliated data sources. This is because any one of the unaffiliated data sources only has an incomplete picture or profile of the user that only includes proprietary information obtained by the data source, whereas the PDC aggregated data profile of the user contains information that is read and collected across multiple unaffiliated data sources.

At operation 740, the information obtained at operation 730 is securely stored in the appropriate data fields of the user profile/template, thereby forming the aggregated data profile of the user. At operation 750, for each data source, operations 730-740 are repeated until each piece of relevant user data maintained by the data sources is stored in the appropriate data field of the user's aggregated data profile. At operation 760, the data in the user's aggregated data profile is updated in real time, or periodically, by repeating steps 720-750 in real-time or periodically. For instance, periodic updates to the users aggregated data profile could occur on a daily basis; or alternatively or in combination, real-time updates could occur if the data sources provide a notification (i.e., an event notification or interrupt) to the PDC that updated data exists or status changes have occurred such that the PDC then obtains such new information and updates the user aggregated data profile. As such, in one embodiment a user's profile is favorably or unfavorably modified via periodic and/or real-time updates for purposes of targeting by third party vendors.

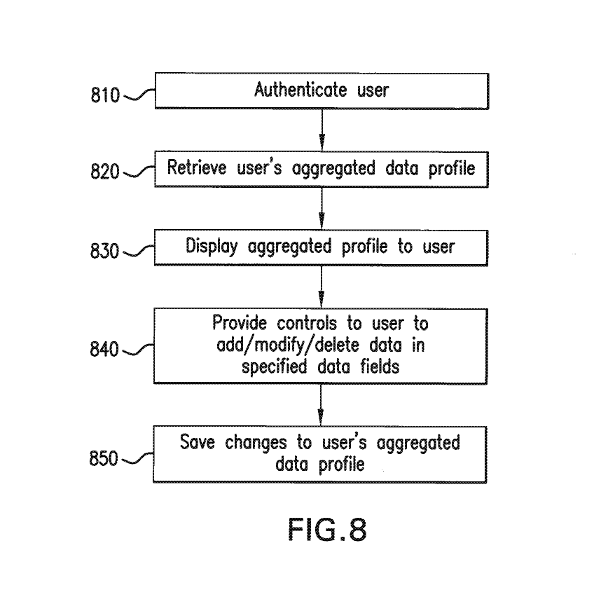

FIG. 8 illustrates an example of a process for enabling user modifications to certain elements of the user's secure aggregated data profile, in accordance with one embodiment of the present invention. In this case, the PDC collects information directly from the user. At operation 810, authentication of the user is performed, which may include authentication by any conventional techniques. At operation 820, having authenticated the user, the user's aggregated data profile is retrieved by the PDC. At operation 830, the users aggregated data profile is displayed to the user for review and editing, such as through a graphical user interface. At operation 840, controls are provided to the user, such as through the graphical user interface, to add/modify/delete data in one or more of the plurality of data fields of the user's aggregated data profile. Operation 840 permits the user to revise, edit, supplement, or delete one or more of the data elements about the user that is stored in the user's aggregated data profile. At operation 850, changes made to the data by the user are securely stored. In this manner, the user is able to view and revise the data maintained in the user's aggregated data profile, which will thereby provide the user with control over one or more of the contents of the users aggregated data profile.

In one example of an embodiment of the invention, product and service offerings can be requested by users (i.e., “pulled”), or sent (i.e., “pushed”) to the users/consumers based on any of the following or a combination thereof: (i) stated user preferences, (ii) tracking of activity related to the user, and/or (iii) specified data and/or changes in data—examples of which could include but are not limited to (a) birth dates, anniversaries, status such as single or married, or religious affiliation. The interaction and overlapping of these different criteria could help to more accurately reflect proposed products/services with a higher level of likelihood of meeting the needs of a particular user/consumer.

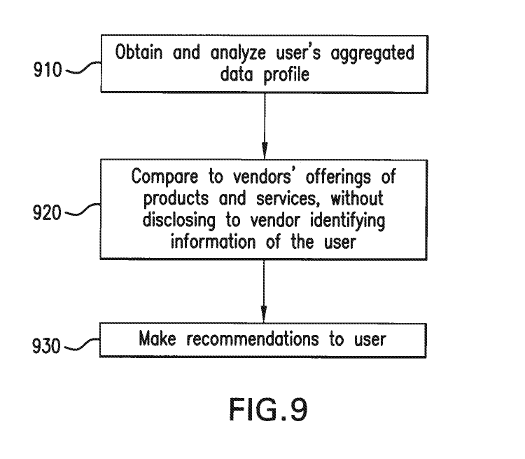

FIG. 9 illustrates a process for recommending products or services to a user based on the user's aggregated data profile, in accordance with one embodiment of the present invention.

At operation 910, a user's aggregated data profile, including the user's preferences and purchasing history, is reviewed and analyzed. At operation 920, the user's aggregated data profile, or specific data fields therein, are compared to the vendor's offerings, without disclosing any user identification information to the vendor. At operation 930, to the extent that there is a match or potential match between a vendors offerings and a user's desire for products or services as expressed in the user's aggregated data profile, one or more recommendations is made to the user. Because the recommendation is made to the user without disclosing any user identification information to the vendor, the recommendations of operation 930 can be made privately to the user.

In one embodiment, information concerning products is collected, in part, through crawling vendor sites online and determining what is available to the consuming public. In another embodiment, the PDC is configured to allow vendors to sign up and directly provide a description of the available products along with pricing, etc. Vendors would be interested in providing this information because as noted in a TechCrunch article entitled The Ecommerce Revolution Is All About You, “ . . . [t]he best way to begin understanding the opportunity of personalization in the future is to realize the immense challenge that retailers face when approaching personalization . . . . When you go to Nordstrom you have a shopping assistant who helps direct you, basically saying ‘I'm here to help, what do you need and here's where to find this.’ No online retailer has quite nailed that . . . [f]or most retailers, the toughest hurdle is to have enough data on an individual to actually help personalize the experience. For the majority of buyers who purchase from a specific site once every few months, or even less frequently, a retailer may have no real sense of direction on how to present similar products.” Reo, Leena. “The Ecommerce Revolution Is All About You.” AOL Tech—Tech Crunch. 29 Jan. 2012, available at http://techcrunch.com/2012/01/29/the-ecommerce-revolution-is-all-about-you.

The above TechCrunch quote highlights difficulties caused by having too little data in connection with a “push” strategy for offering customized offerings to consumers. The existence of a common repository of data concerning the totality of likes, dislikes, preferences, actions, location, etc. for each consumer would enable a highly accurate “pull” strategy in which consumers who are “highly qualified prospects” could request products or services they desire. Embodiments of the present invention would not only make a more effective “pull” strategy possible but would also address issues related to ownership and privacy of consumer data. For example, an aggregated user profiled of a PDC user includes both structured and unstructured data collected from one or more unaffiliated and disparate data sources both online and offline. The user may directly provide structured data online to the PDC that indicates a preference for country music. Additional information about that user is collected by the PDC combination of online and/or offline from an unaffiliated data source, such as a credit card company, that indicates that the user bought tickets to a country music concert highlighting a performance by country music Singer A. From another unaffiliated offline data source, such as a department store, information is collected or delivered to the PDC indicating that the user purchased a t-shirt promoting country music Singer A. As such, the PDC aggregated user profile may indicate that the user is a highly motivated fan of Singer A, and may be willing to purchase additional items and services associated with Singer A. For example, a third party vendor providing suite tickets to an upcoming concert preformed by Singer A may want targeted access to any PDC user who possesses characteristics and/or participates in activity which is considered by the vendor as indicating high potential interest in purchasing the suite tickets. In that manner, the PDC is able to provide access to one or more highly qualified PDC users that may be particularly interested to purchase those suite tickets at a premium. Further, the targeting may be performed in an anonymous or more public manner, as dictated by the user.

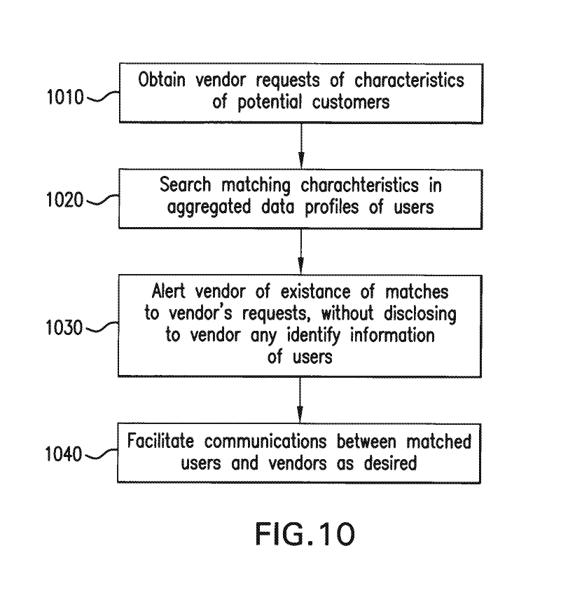

As an example, FIG. 10 illustrates an example of a process for alerting a vendor of the existence of one or more qualified prospective buyers, in accordance with one embodiment of the present invention, in accordance with one embodiment of the present disclosure. At operation 1010, vendor requests for potential purchasers are obtained. In one example, the PDC receives requests from vendors specifying desired characteristics of potential purchasers. For instance, a luxury automotive vendor may request characteristics of potential purchasers including an age range, an income range, a gender, and a geographic region. At operation 1020, a search is conducted in the databases of the system across the aggregated data profiles of a plurality of users to determine any matches between the users aggregated data profiles and the characteristics requested by the vendor. At operation 1030, to the extent that a match exists, an alert is issued to the vendor notifying the vendor of the existence of one or more matches to the vendor's desired characteristics in a potential purchaser, without disclosing any identifying information to the vendor of each of the users that have the matching characteristics. At operation 1040, communications are facilitated by the system between the user and vendor in order to see if the parties are interested in a possible transaction. For instance, if the vendor desires to contact one or more users, the system may notify the one or more users who satisfy the characteristics/behavior specified by the vendor and who have expressly authorized such communications, that a particular vendor is interested in offering the user a product or service, and requesting that the user contact the vendor regarding the possible transaction if the user desires. One difference between the PDC from direct mail houses, ad networks and other means of delivering advertisements is the depth of the information available through the variety of online and offline data sources involved. For example, while the end of the analysis for some services may be that a consumer looked at an Audi A8 website, the PDC may also know through a second data source that the consumer, who looked at the A8 site, also posted on a social media web site that the A8 was not a good automobile to purchase for the consumer's purposes.

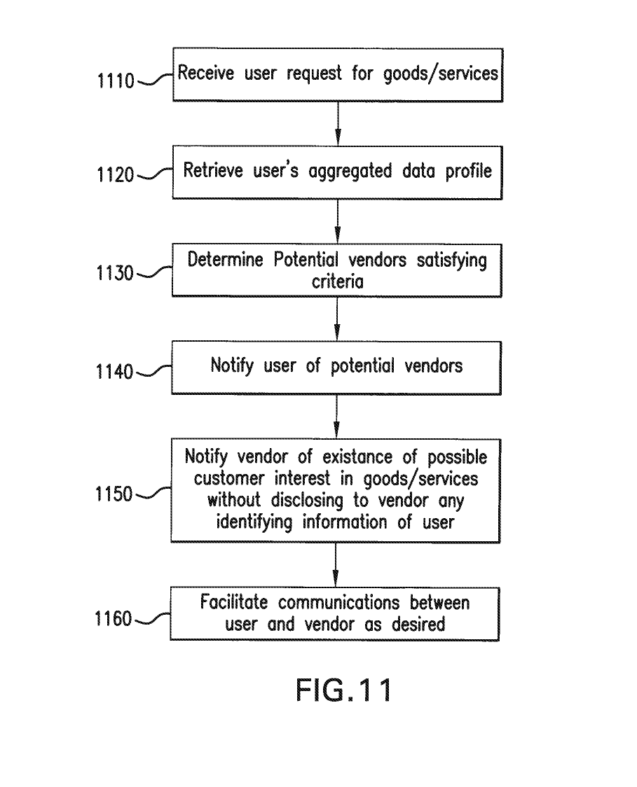

FIG. 11 illustrates an example of a process for alerting a vendor of a qualified prospective buyer based on the user's request, in accordance with one embodiment of the present invention. At operation 1110, a user's request for goods and services is received by the system. At operation 1120, the user's aggregated data profile is retrieved so as to provide the system with additional insights, preferences, and data regarding the user. At operation 1130, in one example, based on the user's request at operation 1110 and based on one or more of the data fields in the user's aggregated data profile obtained at operation 1120, a determination is made as to potential vendors that would possibly satisfy the user's request. At operation 1140, a notification is provided to the user of the vendors identified at operation 1130 which could potentially satisfy the user's request for goods and services. At operation 1150, a notification is provided to the one or more vendors identified at operation 1130, wherein the notification indicates to the vendor that a potential purchaser is interested in a particular good or service. This notification is provided to the vendors without providing identifying information about the user (e.g., the user's name and email address are not provided to the vendor at this time). This information can be utilized by the vendor to help the vendor assess interest levels in products or services being offered by the vendor. At operation 1160, communications are facilitated by the system between the user and vendor in order to see if the parties are interested in a possible transaction. For instance, the system may suggest that the user contact the vendor regarding the possible transaction if the user desires or the system may facilitate a special offer to be offered by the vendor to the user as an incentive for the user to contact the vendor.

Hence, it can be seen that embodiments of the present invention provide for aggregating personal consumer information from a plurality of disparate sources, in order to form a comprehensive and secure data profile of the user that is controlled by each user. In this manner, the user's personal consumer data is protected and the user's privacy while using the internet is enhanced. This anonymity is enhanced both during “research” as well as any “purchasing” phase of their activity by enabling consumers to surf the web through a proxy server to ensure web site analytics do not detect the actual identity of the user. This further exemplifies the fact that the user is able to control use of the information within an associated aggregated user profile, which is enhanced through controlled anonymity of the user.

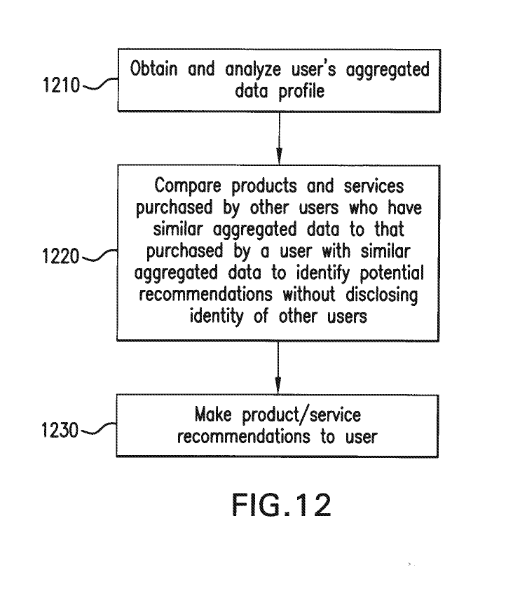

FIG. 12 illustrates a process for recommending products or services to a user based on comparing products or services selected by other users who have data profiles or portions thereof that are similar to the user's aggregated data profile, in accordance with one embodiment of the present invention.

At operation 1210, with a user's permission, the user's aggregated data profile is obtained and one or more elements of the user's aggregated data profile are analyzed to determine one or more characteristics. At operation 1220, other users who have expressly elected to participate in this exercise, are identified that have one or more similar characteristics or traits in their aggregated data profiles when compared with the aggregated data profile of the user as obtained and analyzed at operation 1220. When a match is found between the present user's aggregated data profile and one or more other users' aggregated data profiles, operation 1220 also examines the products and services purchased by those other users in order to identify potential recommendations of products and services for possible purchase by the present user. These recommendations are formulated without disclosing the identity of the present user or of the other users. At operation 1230, the product and service recommendations formulated by operation 1220 are presented to the present user for consideration. In this manner, the aggregated data profiles of each of the users maintained by the system can be utilized to make recommendations to the users within the system of potential products and services that may be of interest without having to reveal the identity of any user. If desired, a user can disable this recommendation feature from their PDC account.

More particularly, embodiments of the present invention distinguish themselves from standard collaborative filtering approaches used in the industry by including data from unaffiliated data sources as well as by including not just buying behavior but also other data in the decision making process. For example, collected information may include wall posts either posted on a user's social networking site about the product, or information related to other posts on the user's wall read from friends' posts about the product. All this collected information helps to shape the type of offer(s) received.

In addition, providing the consumer with a means to further refine the product/service matching recommendations by indicating how close a fit the proposed match or targeting produces help the PDC refine the matching process with respect to that user. Examples of user interaction with the PDC to relay preferences to received targeting include, “good/spot-on”, “bad/way-off”, or similar buttons.

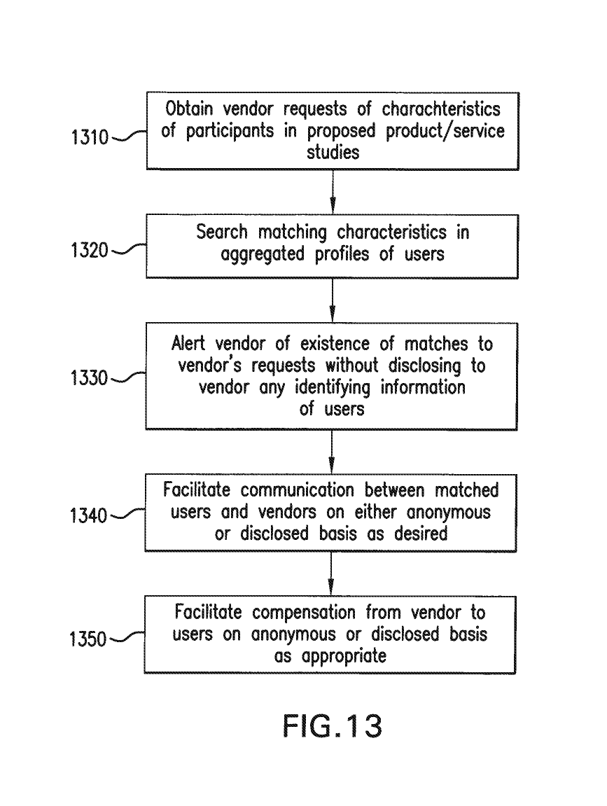

FIG. 13 illustrates an example of a process for enabling a vendor to question one or more interested qualified prospective buyers as to what features and functions they would prefer to see in new product and service offerings, in accordance with one embodiment of the present invention.

At operation 1310, the system obtains vendor requests of characteristics of users in the system, so that such users who have expressly elected to participate in this exercise can be contacted for the vendor's study or survey of the vendor's proposed products or services. For instance, if a vendor is looking to conduct a survey of men between the ages of 25-30 in the northeast part of the country who have an interest in outdoor clothing such as ski jackets, such request is formulated and transmitted to the system.

At operation 1320, the system searches for matching characteristics in the aggregated data profiles of the users within the system who have expressly elected to participate in this exercise, based on the request of operation 1310.

At operation 1330, upon the system locating users having matching characteristics as requested by the vendor, the system alerts the vendor of the existence of matches to the vendors requests, without disclosing to the vendor any identifying information of those matched users. For instance, continuing with the example described above, the system may indicate to the vendor that 724 males have been identified within the system that are between the age of 25-30 in the northeast part of the country who have an interest in outdoor clothing such as ski jackets.

At operation 1340, the system facilitates communications between the match users and the vendors on either an anonymous basis, limited identity disclosure basis, identity disclosed basis, or any variation thereof, as desired by each user. The communications can include controls for each user to accept or decline the vendor's requests that the user participate in the product study or survey.

At operation 1350, the system may be configured to facilitate compensation from the vendors to the users that participate in the vendors study or survey. This may be done on an anonymous basis, limited identity disclosure basis, identity disclosed basis, or any variation thereof, as desired by each user.

Hence it can be seen that embodiments of the system disclosed herein can be utilized to facilitate product or service related studies, surveys or questionnaires to targeted users having certain characteristics as specified by the vendor, without revealing the identities or identifying information (such as email addresses) of the users. This also allows for such studies, surveys, or questionnaires to provide to vendors significantly greater amounts of relevant information from highly targeted audiences, when compared with conventional survey techniques. If desired, a user can disable this feature from their PDC account.

In another embodiment, providing survey type information to vendors allows for a platform configured for connecting those vendors to “influencers” in the desired product/service area. Influencers are identified and respected as a good source of information with regard to a particular product(s) or service(s) and exert influence on the decisions of other prospective purchasers based on their opinions, recommendations and/or actions. Influencers can exist both online (e.g., an influential in social media) and offline (e.g., a neighborhood car expert). By collecting additional metrics about how a user participates in online activities (e.g., within the context of social media) from a variety of disparate data sources and/or how influential the person is on a topic offline, vendors would find this a valuable resource. In one example of the connection between a vendor and an influencer and the benefits provided to a vendor and consumers, a vendor may desire to provide new products/services to one or more influencers for free in exchange for them either providing feedback and/or talking about the products/services in their online and offline networks.

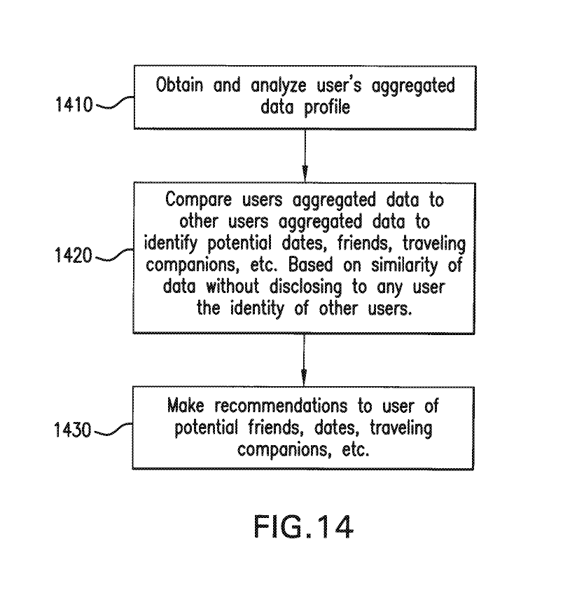

FIG. 14 illustrates a process for recommending potential friends or dates to a user based on the user's aggregated data profile, in accordance with one embodiment of the present invention. This feature, which is shown in one example as 62 in FIG. 3, can be enabled or disabled by a user within their account, depending upon the particular implementation and desire of the user.

At operation 1410, the system obtains and analyzes aggregated data profiles of a plurality of participating users. At operation 1420, the users' aggregated data profiles are compared to other users' aggregated data profiles, in order to identify potential commonalities between the users, assess commonalities that can be used to form the basis for recommending potential friends, traveling companions, dates, affiliations, social network connections, or other connection or relationship development. Operation 1420 is performed without disclosing, to any user, any identifying information of other users. As part of the aggregated data profile comparison, the system can examine the dynamic real-time activity data of various users as contained within each users aggregated data profile, such activity data including hobbies, interests, actual activities performed and recorded in the aggregated data profile such as exercise, product purchases, restaurant choices, or other activities. This information extends well beyond the static profile information submitted by users when they fill out their profile; and instead includes dynamic information based on a user's actual real-time activities and other actions.

At operation 1430, recommendations are formulated and made to a user of potential friends, traveling companions, dates, affiliations, social network connections, or other connection or relationship development. What differentiates some embodiments of the invention from current matching sites is having access to multiple unaffiliated data sources such as social media posts, websites visited, articles read (among other things) both online and offline which would provide additional details to enable greater likelihood of successful matches based on common likes, dislikes and similar factors. As such, the aggregated data profile of the user includes information of greater variety and number, which in turn provides more accurate information relating back to the user.

Hence, it can be seen that embodiments of the present invention can be utilized to make relationship recommendations to one or more users and the system based on users' dynamic, real-time information as maintained in their aggregated data profiles.

Embodiments of the present invention can also be used by vendors, manufacturers, retailers, advertisers, and other entities wishing to identify, on an anonymous basis, potential customers that meet the vendors criteria, thereby providing the vendors with highly qualified leads to potential customers. The system can then facilitate communications between a user and a vendor in order to conduct a transaction such as a purchase of a product or service.

Some examples of possible uses of embodiments of the present invention are described herein. For instance, one consumer benefit to aspects of the present invention is that the system can provide users with anonymity while shopping. For instance, the identity of a user conducting research on potential cars can be kept confidential and when purchasing a car a user can receive offers based on their priorities as filtered through the PDC system without having to reveal their identity. By using the facilities of the PDC, car dealers do not have consumer contact information unless expressly authorized by users and therefore cannot bombard the users with unwanted or hard-sell communications or marketing.

Another example is that consumers will be able to control and profit from the disclosure of their identity information. Everyone knows that when a person gives their name to one mailing list, that information is sold to other lists and third parties. Through the use of aspects of embodiments of the present invention, consumers have the opportunity to not only take control, but also to profit by providing their data to sources that will pay for it (e.g., FIG. 13).

Another benefit to embodiments of the present invention is that users will, over time, receive marketing that is more relevant to their interests. iTunes™ knows what music you like; Amazon™ knows what books you read; Open Table™ knows what restaurants you like; other companies know where you live and your hobbies. As that information is aggregated by the PDC with the express permission of users as described above, the cross-platform data can be used to improve the relevance of offers made to the users. For instance, if Amazon knew what music you liked using embodiments of the present invention, it could recommend a book you would love; if Open Table knew you just bought a book on Indian Cooking, it could recommend a new restaurant in your neighborhood using embodiments of the present invention, and Groupon™ could send you an offer to such restaurant. If iTunes knew where you lived, using embodiments of the present invention, it could recommend a concert as soon as the concert was announced so that you could purchase great seats early on.

Another benefit to embodiments of the present invention is that companies can obtain information from embodiments of the system to refine locations for upcoming events. For instance, if Tina Turner's record label company is looking for locations to perform a few select shows, embodiments of the system can tell the company, without revealing any names or otherwise identifying information, that 75% of the residents of a small town in Colorado have purchased more than one Tina Turner album from Amazon or iTunes within the last year. The record label company can then plan a concert with high prospects of success in a town that would have otherwise been overlooked.

Another benefit to embodiments of the present invention is that companies or vendors can use embodiments of the present invention to make targeted time sensitive or inventory sensitive offerings. For example in the field of specialty foods, assume a high-end specialty food store ordered rare matsutake, or mattake mushrooms at a cost of $1,000 per pound. The demand for the mushrooms was less than expected and 100 pounds of mushrooms must be sold within the next hour or risk becoming worthless. By leveraging real-time Global Positioning Satellite (GPS) information and stored eating/purchasing data as maintained by embodiments of the present invention, the system could alert the food store of users with expressed interest in matsutake mushrooms that are or become proximately located within 10 miles of the store over the next hour so the store can offer such users a special price to purchase the mushrooms, which could result in sales significantly at higher rates and prices than to a less qualified or interested group of customers.

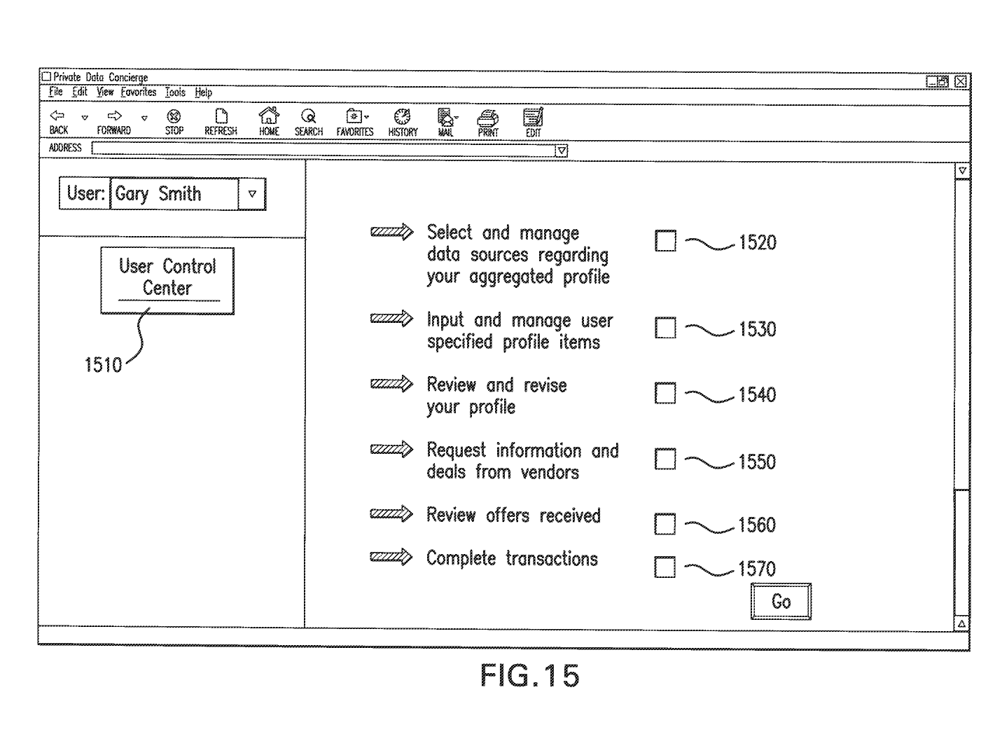

FIGS. 15-29 illustrate various examples of computer display screens illustrating various features, controls, and data fields of graphical user interfaces that can be used with embodiments of the present invention. It is understood that the example display screens, controls, data fields, and graphical user interfaces provided herein are provided by way of example only as to examples that can be used with embodiments of the present invention if desired. Embodiments of the invention can be formed using one or more features or functions shown in the example display screens, or embodiments of the invention can be formed using other display screens, controls (such as check boxes, hyperlinks, buttons, menu options), data fields, and graphical user interfaces as desired depending on the particular implementation of the invention. These display screens, controls, data fields, and graphical user interfaces can be implemented within a browser or within an application program such as in a mobile device or other program operating on a computing device or system.

Referring to FIG. 15, an example of a computer display screen of a PDC for a user is illustrated, in accordance with one embodiment of the present invention. For instance, for a user's account “Gary Smith” once he has been authenticated and logged into the system, the example display screen of FIG. 15 may be provided as a user control center 1510. By way of example, controls may be provided for the user to: select and manage the plurality of disparate data sources that can be used to obtain data from in order to formulate the users aggregated data profile (control 1520); input and manage user-specified profile items and data fields (control 1530); review and revise a user's aggregated data profile (control 1540); request information, offers, and deals from vendors (control 1550); review offers received from vendors (control 1560); and complete transactions with vendors (control 1570).

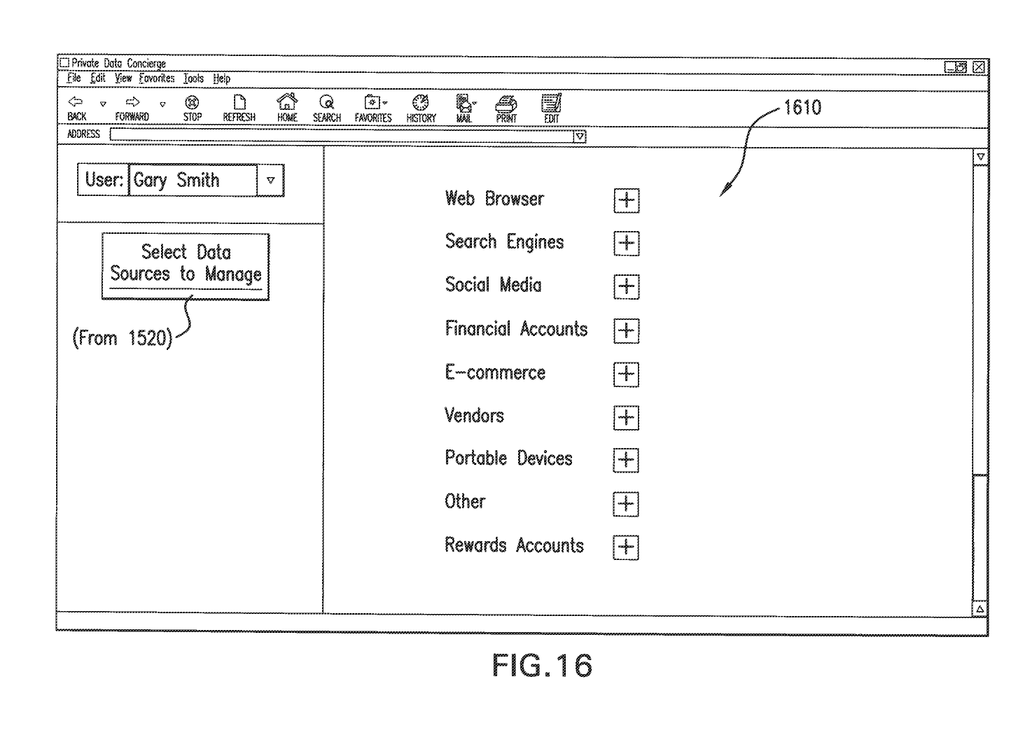

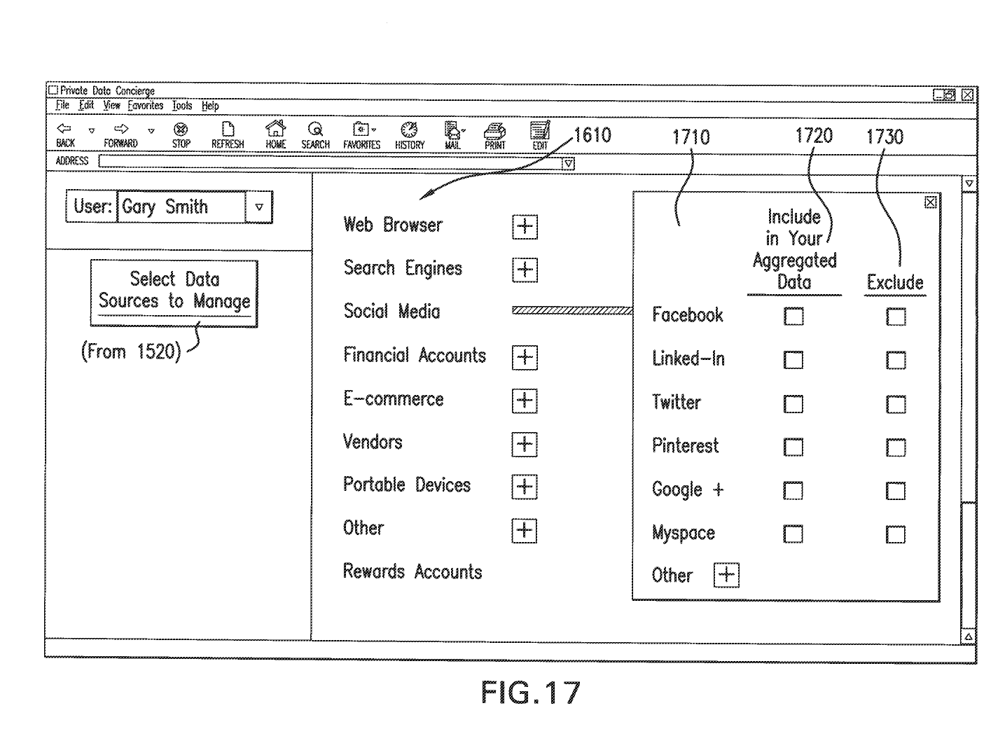

Assuming the user selects the control 1520 to “Select Data Sources to Manage”, in FIG. 16 the graphical user interface may include a list 1610 of categories of various disparate data sources from which the PDC system can ping, poll or otherwise communicate with in order to gather the user's personal data as maintained on that particular data source, in accordance with one embodiment of the present disclosure. In the example of FIG. 17, the user selects management of the category of “Social Media” data sources; and in response, the graphical user interface provides a list 1710 of social media data sources (e.g., social media websites or services), and for each social media data source, a control 1720 is provided for the user to include that data source in the user's aggregated data profile, and a control 1730 is provided for the user to exclude that data source in the user's aggregated data profile, in accordance with one embodiment of the present disclosure. In one example, upon the user selecting to include a data source in the user's aggregated data profile, the PDC securely communicates with that data source in order to receive all data relating to the user that is maintained by that data source. The PDC system then securely stores that information in its databases as associated with the users aggregated data profile in the user's account. As described herein, the system may periodically, or on an event-driven basis or otherwise, communicate with such data source to obtain recent or real-time data from the data source as it relates to the user.

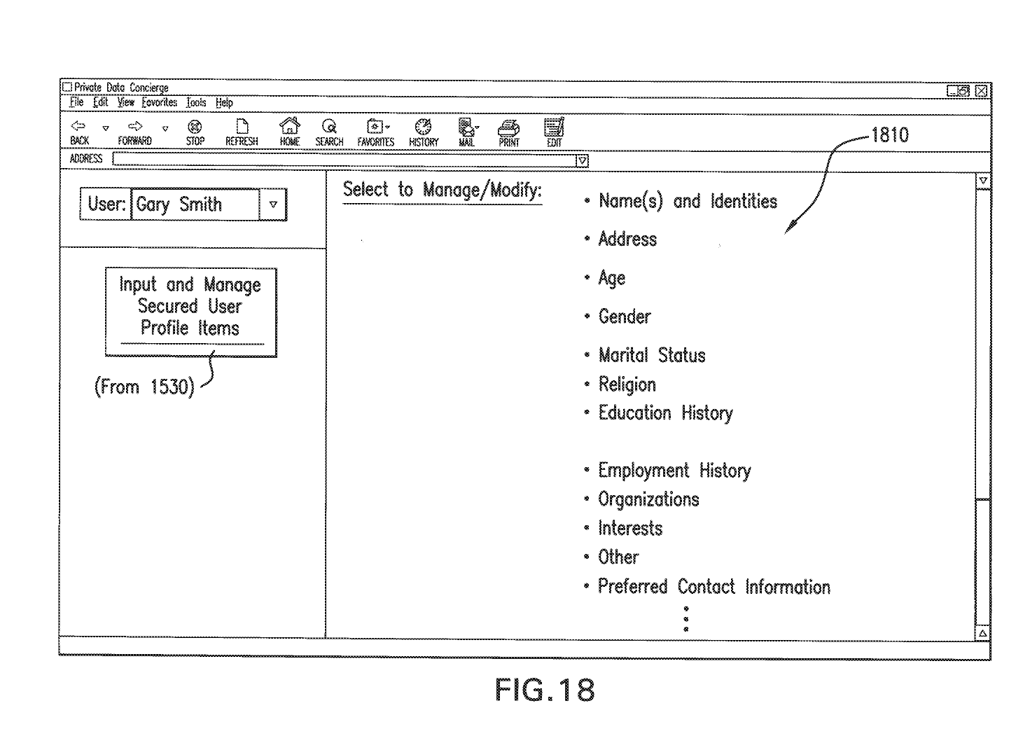

In the example display screen of FIG. 18, controls, links, and data fields may be provided in a graphical user interface to enable the user to input and specify one or more items of personal information 1810, in accordance with one embodiment of the present disclosure. Such information can include, but is not limited to, the user's name and identities, address, age, gender, marital status, religion, education history, employment history, organizations and memberships, interests, preferred contact information for use by the system, or other information related to the user. This information is stored by the system in the user's aggregated data profile, in one example.

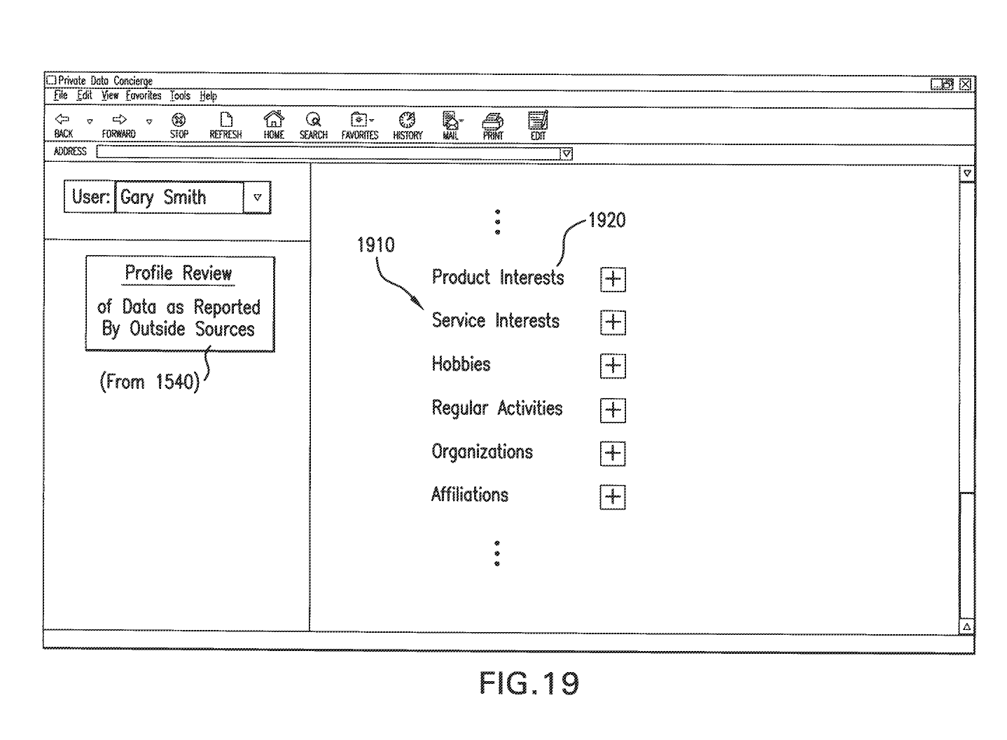

In the example display screen of FIG. 19, controls, links, and data fields may be provided in a graphical user interface to enable the user to review one or more categories of fields 1910 of the user's aggregated data profile as reported by the various data sources, in accordance with one embodiment of the present disclosure. As shown in FIG. 19, various categories of data fields 1910 are shown, including but not limited to, product interests (shown as 1920), service interests, hobbies, regular activities, organizations, affiliations, or other categories depending upon the particular implementation. Any of the data fields or categories of data fields of an aggregated data profile for instance as shown in FIG. 6, or as described herein, may be provided in a graphical user interface for review by the user. In one example, this information could include, but would not be limited to, a histogram of brand/product names derived from sites visited, the inclusion of previous purchase data, sentiment expressed on brands/products from social media posts, an assessment of how far along the user is in the purchase cycle, and similar information.

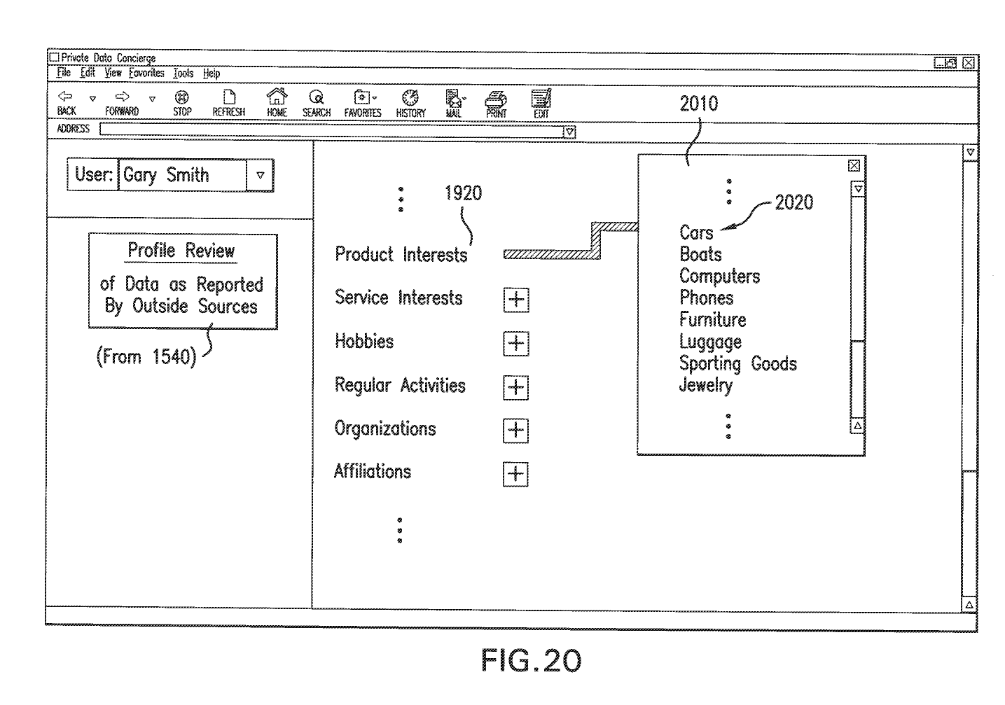

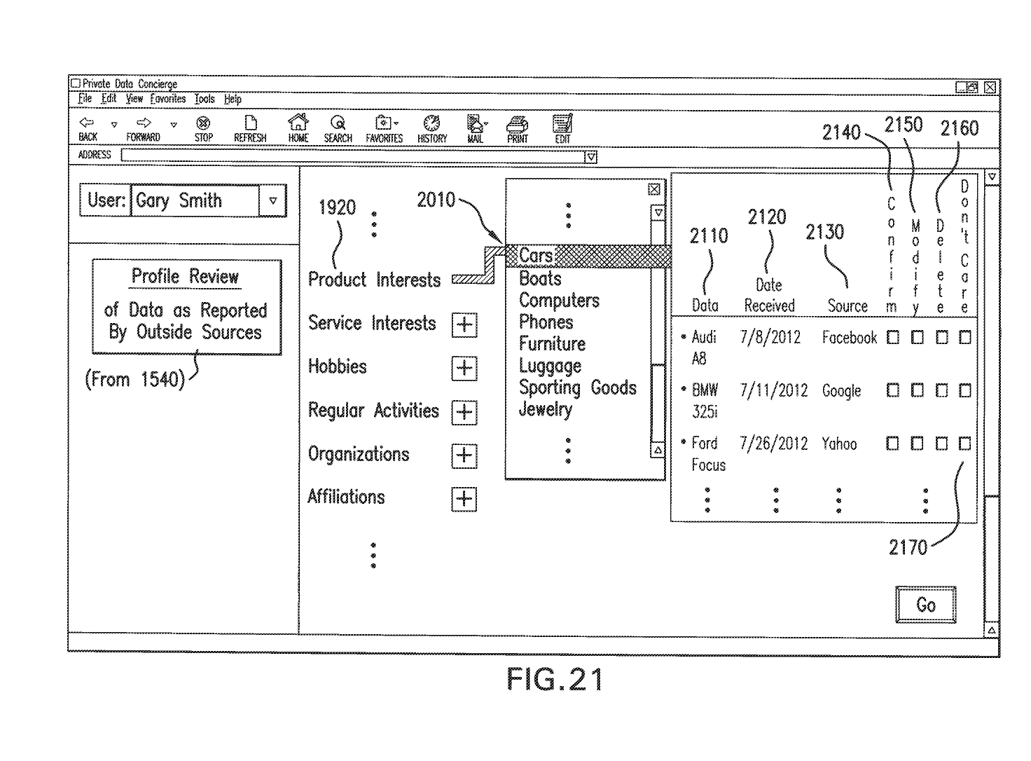

In FIG. 20, assuming the user has selected to review the data associated with the user's product interests (shown as 1920), a graphical user interface can include a list 2010 of categories of product interests as shown in FIG. 20 by way of example, in accordance with one embodiment of the present disclosure. Assuming the user selects the category of “Cars” (shown as 2020) in FIG. 21, the data stored by the PDC for the category of Cars is displayed to the user. In one example, the information displayed includes a field 2110 for the data, a field 2120 for the date the data was received, and a field 2130 for the source that provided the data. The graphical user interface may also include one or more controls 2140 to allow the user to confirm an item of data; controls 2150 to modify an item of data; controls 2160 to delete an item of data; or controls 2170 to indicate the user does not care as to the item of data. In this way, the graphical user interface provides the user with control as to the content of the data as maintained by the PDC system. Note that while the PDC allows users to revise the types and descriptions of user interests in products and services, other data elements about the user can be configured as read-only data such as a user's credit score or social security number (to the extent that these items are authorized by the user to be maintained by the PDC). In one example of the invention, read-only data items in a user's aggregated data profile cannot be revised by the user. Also, the interactions of the user with his or her data via the interface could be further used to refine the data/recommendation engines embodied within the invention to refine processes to generate more accurate recommendations for the individual user and across the network.

By way of explanation of the example of FIG. 21, the social media site Facebook reported to the PDC that the user has a product interest in a car of an Audi A8; Google reported to the PDC that the user has a product interest in a car of a BMW 325i; and Yahoo reported to the PDC that the user has a product interest in a car of a Ford Focus.

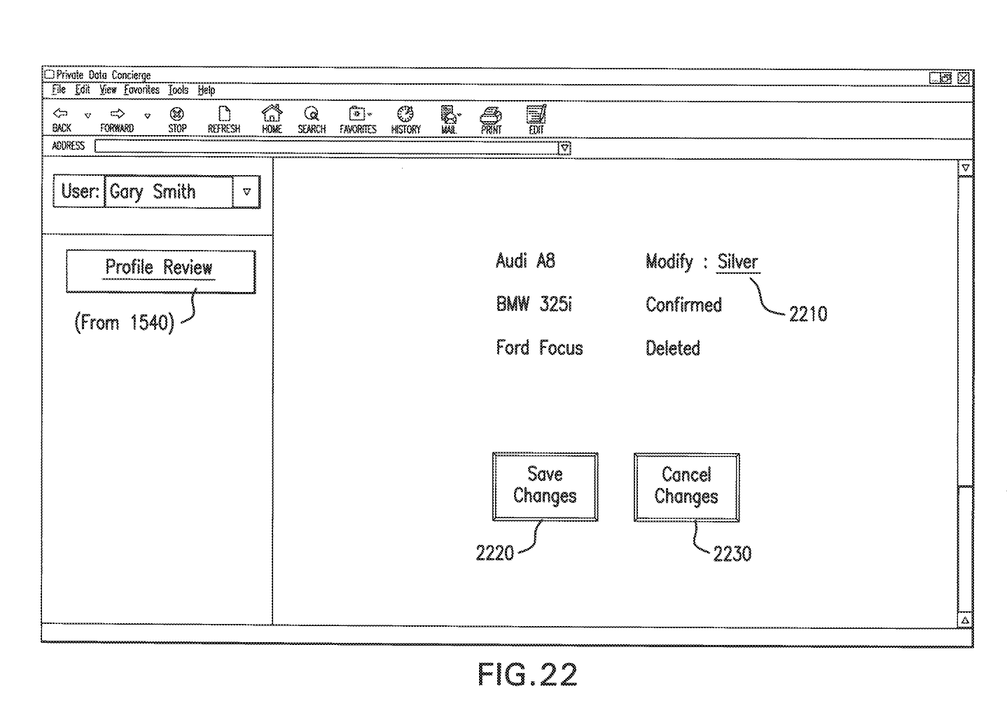

Assume that the user wishes to correct and confirm aspects of his aggregated data profile as to his interests in cars—such that the user would like to be more specific as to his interest in the Audi A8 and selects the Modify control 2150 for the Audi A8; wishes to confirm his interest in the BMW 325i by selecting the Confirm control 2140 for the BMW 325i; and wishes to delete the data related to an interest in the Ford Focus by selecting the Delete control 2160 for the Ford focus. Then in FIG. 22, a field 2210 is provided for the user to enter more specific information as to the user's interest in the Audi A8. The display also indicates the user's confirmed interest in the BMW 325i and also indicates that the user has deleted data related to an alleged interest in a Ford Focus. Controls 2220, 2230 are provided for the user to save (or cancel) these changes to the user's aggregated data profile as maintained by the PDC. It can be seen that in this manner, embodiments of the present invention provide the user with control of the specific data items that comprise the user's aggregated data profile as maintained by the PDC; and that the user can (as the user desires) confirm, modify, or delete specific data items within an embodiment of the user's aggregated data profile. In this manner, the user's aggregated data profile can be tailored by the user to be an accurate reflection of the user and of the user's current interests in products and services. Also, the interactions of the user with his data could be further used to refine the data/recommendation engines embodied within an embodiment of the invention to refine processes to generate more accurate recommendations for the individual user and across the network.

If desired, one or more controls can be provided to enable the user to prioritize or weight one or more user interests or user characteristics relative to other interest or characteristics (or in absolute form) as maintained in the user's aggregated data profile. For instance, in the example above, if the user is more interested in a silver-colored Audi A8 than the user is interested in a low price, a graphical user interface can be developed which provides the user with an ability to indicate such prioritization or weighting of such interests relative to one another or in absolute form.

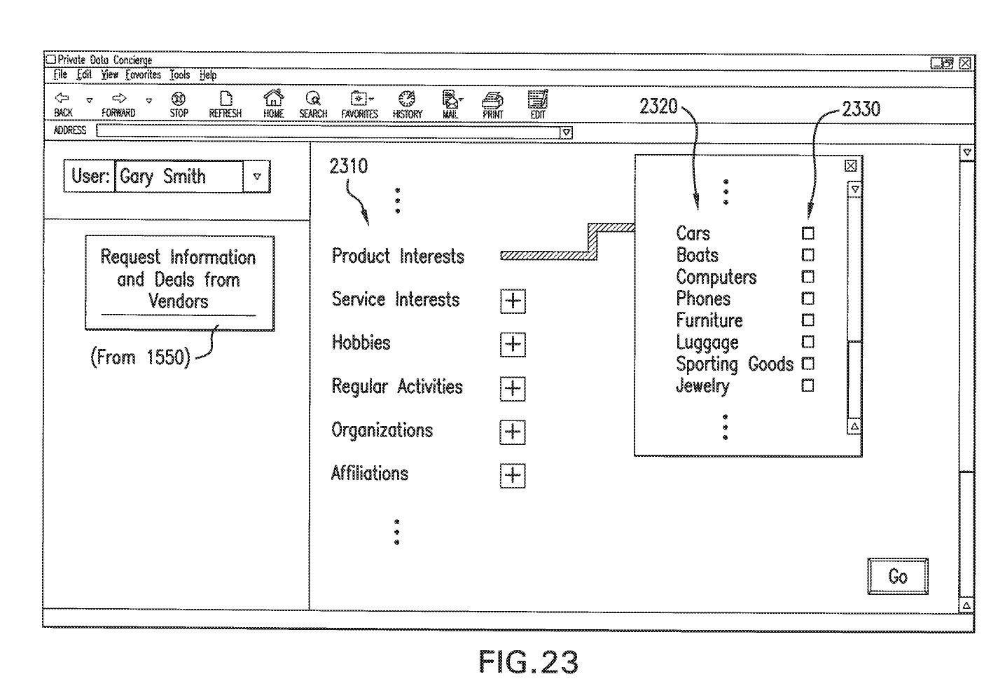

Having gathered various data items related to the user from disparate data sources to form the user's aggregated data profile, and having provided the user with the controls 2130, 2140, 2150 to confirm, modify, or delete specific items of data in the user's aggregated data profile, the aggregated data profile can be utilized for various purposes as described herein for the benefit of the user and, with the express permission of the user, for the benefit of various vendors, companies or other entities. In FIG. 23, an example graphical user interface is shown wherein a user may request information from vendors using one or more aspects of the PDC as described herein, in accordance with one embodiment of the present disclosure. In the example of FIG. 23, a set of categories 2310 can be displayed such as products, services, and others, and assuming the user selects the Product category, a set of subcategories 2320 can be displayed with controls 2330 permitting the user to examine possible vendors within such subcategories for possible transactions therewith.

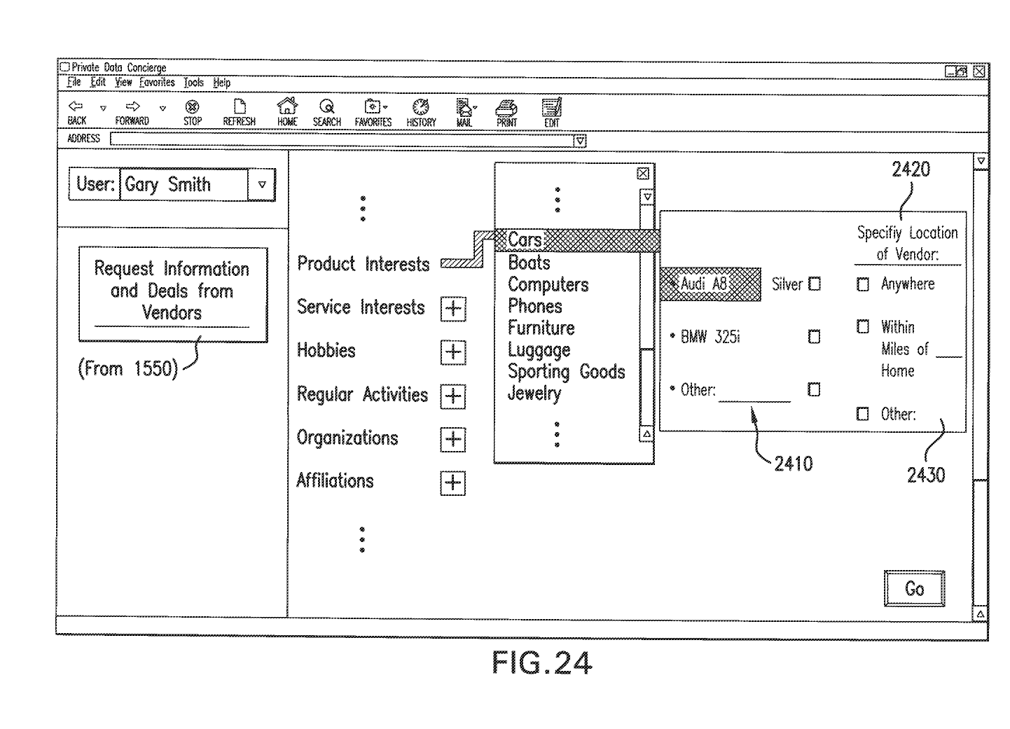

Assuming that the user has selected the “Cars” subcategory, the graphical user interface (FIG. 24) can populate the display with the types of products (in this case, cars) that the user has expressed an interest in as determined by the data stored in the users aggregated data profile. In this example, the user has confirmed interest in an Audi A8 of silver color, and a BMW 325i. A field 2410 may be provided in the graphical user interface for the user to specify a different type of car product if desired. In one example, other fields or controls 2420, 2430 may be provided for the user to specify or narrow the user's interest in such products; in this case example, controls 2420 for specifying a location of a vendor are provided in FIG. 24 as an example. In this manner, the user can specify the product that the user is interested in, as well as other limits or search parameters 2430 as desired. The graphical user interface can be adapted to include context specific controls that vary based upon the type of product, service, or other item that the user is seeking information upon.

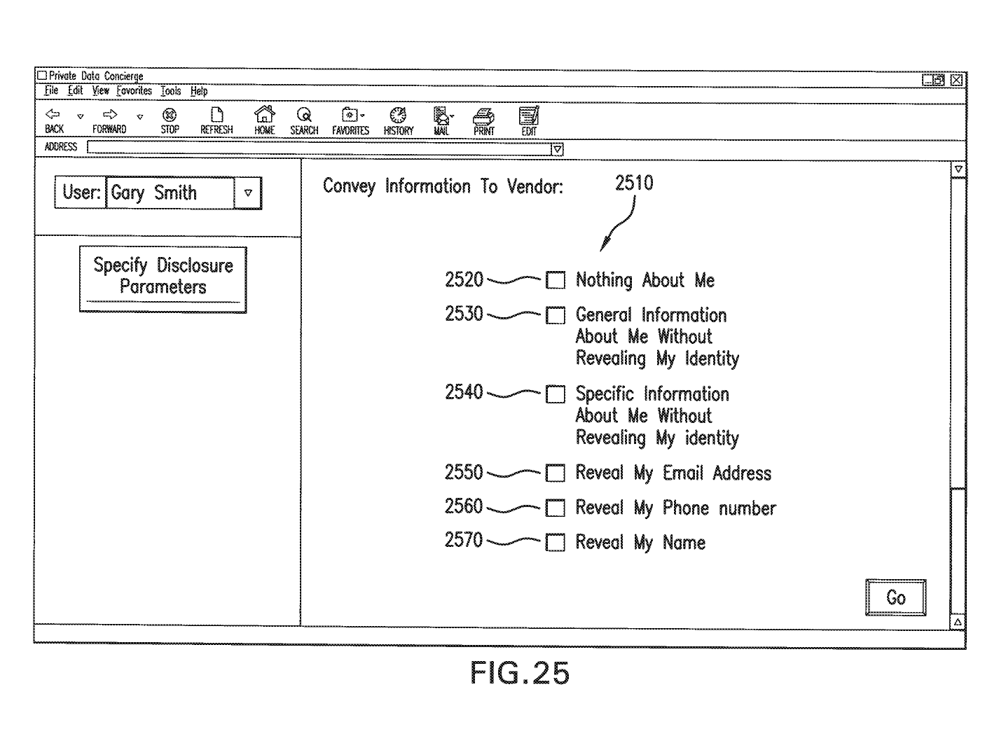

FIG. 25 show an example of a graphical user interface including controls 2510 to permit the user to specify the amounts of personal information of the user to disclose to vendors by the PDC, in accordance with one embodiment of the present invention. In example of FIG. 25, control 2520 is provided to permit the user to specify that nothing about the user be disclosed to the vendor; control 2530 provides that general or first level information about the user can be disclosed to the vendor without revealing the user's identity—this first level of information could initially include in one example basic information such as age range, gender, city/state, student/working which could be completed, deleted or added to by each user so they can customize the level of detail they were comfortable divulging as a first level disclosure to vendors; control 2540 provides that more specific information about the user can be disclosed to the vendor without revealing the user's identity such as specific age, credit score, income level, city of residence, etc. gender or other general data items relating to the user; control 2550 provides that the user's e-mail address may be disclosed to the vendor if desired by the user; control 2560 provides that the user's phone number may be disclosed to the vendor if desired by the user; control 2570 provides that the user's name may be disclosed to the vendor if desired by the user. Embodiments of the present invention can therefore provide each user the opportunity to establish a customizable set of levels of information which they are comfortable disclosing to each vendor at different points of interaction with that vendor.

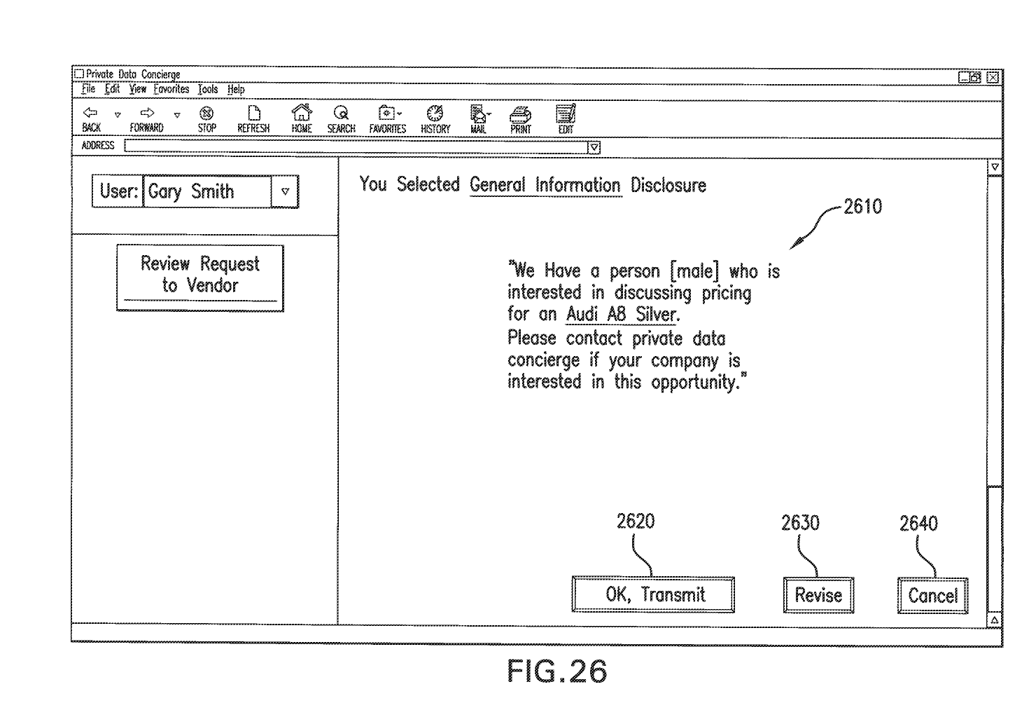

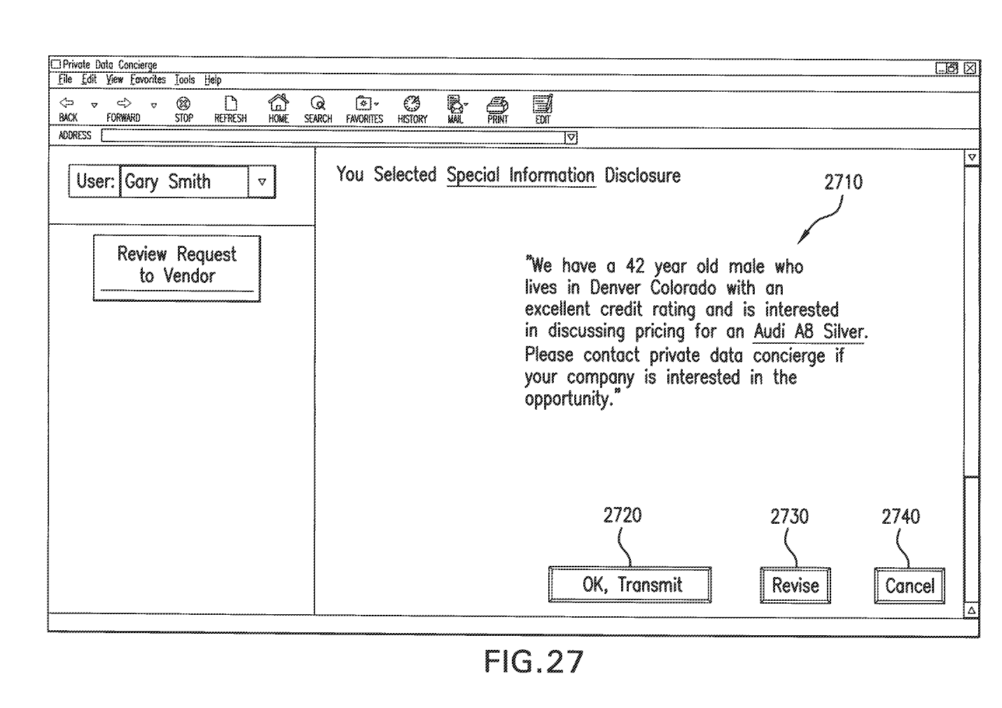

In FIGS. 26-27, according to one aspect of an embodiment of the present invention, a graphical user interface display may be provided in which the PDC system displays, for review by the user, the information 2610 that the PDC system will disclose to the vendor. The amount of information disclosed by the system to the vendor can be based upon the user's selections in the example of FIG. 25. For instance, in FIG. 26, if the user selected “General Information disclosure” (using control 2530) in FIG. 25, then the information disclosed to the vendor will be general in nature, first level personal information (for instance, the user's gender only) and is displayed to the user for approval, and one or more controls 2620, 2630, 2640 can be provided in the graphical user interface (FIG. 26) for the user to accept the transmission of the information to the vendor, revise the information to be transmitted to the vendor, or cancel such transmission.

Alternatively, in the example of FIG. 27, if the user selected “Specific Information disclosure” (using control 2540) in FIG. 25, then the information disclosed to the vendor will be more specific, second-level personal information 2710 (for instance, includes the user's age, city of residence, and credit rating) and is displayed to the user for approval, and one or more controls 2720, 2730, 2740 can be provided in the graphical user interface (FIG. 27) for the user to accept the transmission of the information to the vendor, revise the information to be transmitted to the vendor, or cancel such transmission. The levels of disclosure could also be user defined by creating a screen with radio buttons for each item in the user's profile and let him decide what any vendor sees either on a one-off basis and or allowing the user to define what is in each level of information by checking radio buttons. The PDC can start with default items for each level (certain radio buttons already clicked for level 1, those plus a few more for level 2, etc.) and the user would have the ability to either use the preset levels and information contained at that level or customize the levels and information contained within each level, in one example.

The user's interest in a product is communicated, at the request of the user, by the PDC to one or more vendors that the system identifies as potential vendors that can satisfy the user's interest. For instance, in this example of FIGS. 26-27, given that the user has requested information about an Audi A8, the PDC determines which vendors in its network possibly carry such products. The information request message (such as 2610 or 2710 in the examples of FIGS. 26-27) is transmitted by the PDC to such vendors. On the vendor side, the vendors receive the information request message; and if one or more vendors have products, services or other information that can satisfy or assist with the request, each such vendor then can communicate with the PDC system with information relevant to the user's requested parameters. For instance, the vendors can communicate an offer including data related to product or service descriptions, price, deal terms, and contact information of the vendor.

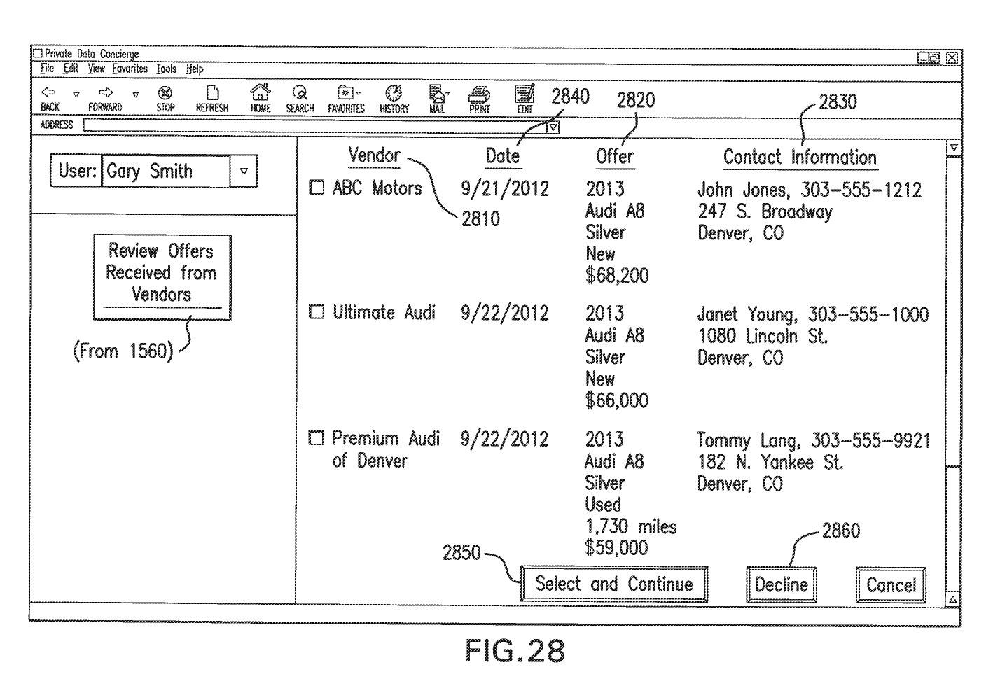

Referring to FIG. 28, an example graphical user interface of a user's display is shown wherein the user is presented with the various offers and details thereof made by the vendors that responded to the user's information request. In this example of FIG. 28, three different vendors 2810 have responded to the user's information request and have provided data 2820 related to descriptions of the products offered and the deal terms, along with the vendor's contact information 2830. This information is displayed to the user in the graphical user interface, along with the date 2840 that the PDC system received such information, as shown in the example of FIG. 28. In one example, controls 2850 are provided within the graphical user interface for the user to select to proceed with one or more offers as presented by the various vendors or decline offers via control 2860. Also, the interactions of the user with his data could be further used to refine the data/recommendation engines embodied within an example of the invention to refine processes to generate more accurate recommendations for the individual user and across the network.

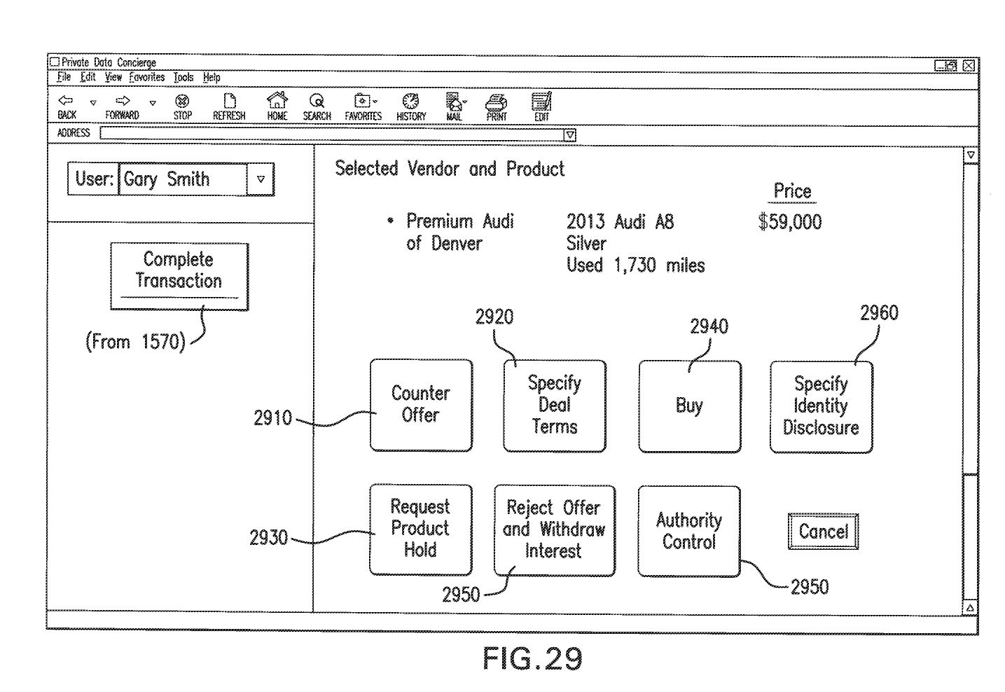

There are various manners in which embodiments of the PDC can facilitate transactions between users and vendors. For instance, one or more controls in a graphical user interface can be provided for the user to advance a possible transaction with the vendor; for instance as shown in the example of FIG. 29, controls may be provided for permitting a user to ask questions related to an offer or related to a product or service; to make a counteroffer (control 2910), to specify deal terms (control 2920), to place a down payment on a product or service or to request a hold on a product or service (control 2930), to buy the product or service (control 2940), request a test drive, request vehicle history, request the Vehicle Identification Number (VIN), or enter a free form text question. The PDC could also provide a user with information regarding the experience of other users of the invention with this vendor either by means of responses to questionnaires distributed to other users who had conducted business with this vendor or statistical information such as “8 others like you purchased vehicles from this dealer (or another dealer in the area) and 6 have rated them excellent.”

Also, access to third party information sources that are relevant to vendors can also be provided to users such as hyperlinks to Better Business Bureau reports on the vendor, or “Car Fax” reports which would provide title, accident and repair history for the VIN.

Also, as shown in the example of FIG. 29, one or more controls in a graphical user interface can be provided for the user to communicate to the vendor the user's rejection of an offer and/or the user's withdrawal of interest in the product or service (control 2950), or whether they are still “Thinking About It” which would prompt a subsequent communication with the user on how the decision is coming.

In addition, one or more controls 2960 may be provided for a user to specify the level of identity disclosure of user information to the vendor. For instance, as the possible transaction moves forward, the user may desire to disclose more personal information about the user, such as but not limited to the user's email address, mobile phone number, credit rating or score, and/or similar information to advance the dialogue with the vendor and as the transaction is being finalized, the user may wish to disclose the user's name, address, and payment information such as credit card data. This could be facilitated by providing the user with customizable radio buttons that would enable them to select which level of detailed information to provide to a vendor at different points in their interaction with each vendor. Alternatively, the PDC can provide access to or utilize third-party payment mechanism (such as PayPal™ or other conventional payment mechanisms), so that the user's identity, credit card information or other related data need not necessarily be disclosed to consummate the user's transaction with the vendor.

Once payment is arranged or made, the PDC can gather information relating to order fulfillment if desired. Also, an optional survey of questions about the vendor could be asked of the user immediately after the purchase as well as at subsequent intervals to provide feedback about the vendor, the product and aid in modeling as well as potentially offering up the feedback when another user is thinking about buying that product or using that vendor.

In still another embodiment, the PDC is configured to provide users that are authority figures the capability to set up and exercise control over accounts for one or more subordinates. Examples of authority/subordinate relationships include parent/child and employer/employee relationships. These accounts can have established levels of detailed information and/or transaction authority that can be provided to third parties or to colleagues that cannot be overridden without access to a special password, multi-factor authentication (MFA) device or other means so that the capabilities of the PDC can be set and controlled by the authority. In the case of a parent/child account, this control provides for the beneficial protection of children. In the case of an employer/employee account, this control provides for management of permissible activities by employees. FIG. 29 illustrates an implementation of authority control through the use of a control button 2950.

In still another embodiment, access to services provided by the PDC engine is provided for non-members on a limited basis. This non-member, open-to-the public aspect can be implemented for purposes of attracting additional users to use services and products provided by the PDC engine. As such, the non-member use of the PDC allows non-members access to a subset of the benefits afforded to those who are members. For example, a non-member may use the PDC engine and/or platform to take advantage of a television deal (e.g., purchase of a high-definition 60 inch, flat screen television) negotiated by the PDC for the benefit of its members.

Hence, it can be seen that embodiments of the present invention provide for a user to form an aggregated data profile using personal information obtained from disparate data sources; and provide for a user to review and revise various data elements as reported by each data source that make up the user's aggregated data profile. Embodiments of the invention also facilitate users and vendors to exchange offers and other information to facilitate purchases of products and services. Embodiments of the invention also facilitate users being made aware of other users with whom they share common interests, activities and/or other factors to facilitate recommending potential friends, traveling companions, dates, affiliations, social network connections or other connections or relationship development. Embodiments of the invention also facilitate the creation of accounts which enable authority figures to exercise control over the activities of subordinates.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. A computer-implemented method for collecting data related to a user and providing the user with control over said data, comprising:
providing, by a computing device, for a user to select one or more unaffiliated data sources to be accessed to collect said data;
collecting, on the computing device, said data from the unaffiliated data sources selected by the user;
aggregating, on the computing device, said data collected from the unaffiliated data sources by the collecting operation;
normalizing, on the computing device, said data from the aggregating operation into a standardized form;
generating, on the computing device, an aggregated data profile associated with said user based on said data from the normalizing operation, wherein said aggregated data profile comprises a plurality of characteristics of said user;
providing access, by the computing device, to the user to securely review the user's aggregated data profile as generated by the generating operation;
providing, by the computing device, the user with one or more controls to revise one or more characteristics contained in the user's aggregated data profile, thereby forming user-revised characteristics;
providing, by the computing device, the user with one or more controls for the user to authorize release of said user-revised characteristics as contained in the user's aggregated data profile to one or more third parties without disclosing an identity of the user by associating a dynamically changing unique identifier with the user;
releasing, by the computing device, said user-revised characteristics to one or more third parties only when authorized by the user; and
providing, by the computing device, one or more items of content in association with the dynamically changing unique identifier of the user in response to the user-revised characteristics, thereby not disclosing the identity of the user outside of the computing device.

2. The method of claim 1, wherein said collecting further comprises:
receiving a user name and a password from said user that provides access to one or more items of data relating to said user on an unaffiliated data source;
requesting access to said unaffiliated data source using said user name and said password;
retrieving at least one item of data relating to said user; and
incorporating a representation of said one item of data within said aggregated data profile.

3. The method of claim 1, wherein said collecting further comprises:
automatically scraping a web site for an item of data relating to said user;
incorporating a representation of said one item of data within said aggregated data profile.

4. The method of claim 1, wherein said collecting further comprises:
receiving one item of data from an unaffiliated data source, wherein said one item was generated through offline actions by said user, and wherein said unaffiliated data source comprises an entity with whom said user has an offline relationship allowing said entity to retain information concerning said user.

5. The method of claim 4, wherein said plurality of unaffiliated data sources comprises an offline data source.

6. The method of claim 1, further comprising:
collecting at least one item of data relating to said user from an unaffiliated data source under authorization by said unaffiliated data source; and
incorporating a representation of said at least one item of data in said aggregated data profile.

7. The method of claim 6, wherein said at least one item of data relating to said user comprises proprietary data owned by said unaffiliated data source.

8. The method of claim 1, further comprising:
collecting a plurality of items of data relating to said user from a plurality of unaffiliated data sources under authorization by each of said plurality of unaffiliated data sources; and
incorporating a plurality of representations of said plurality of items of data into said aggregated data profile.

9. The method of claim 8, further comprising:
anonymously incorporating said plurality of representations into said aggregated data profile, such that an item of data obtained from a first data source is not available to a second data source.

10. The method of claim 1, wherein said collecting further comprises:
collecting at least one item of data relating to said user derived by said unaffiliated data source under authorization by said user.

11. The method of claim 1, further comprising:
receiving a request from the user to delete an item of personal consumer data in the aggregated data profile associated with said user; and
deleting said item of personal consumer data from said aggregated data profile.

12. The method of claim 1, wherein at least one of said unaffiliated data sources comprises an entity with whom said user has an online relationship allowing said entity to retain information concerning said user, wherein said entity is taken from a group consisting of:
an electronic commerce site;
an internet search engine;
a social networking site;
a credit card company; and
a bank.

13. The method of claim 1, further comprising:
receiving at least one item of data relating to said user directly from a computing resource associated with said user; and
incorporating a representation of said at least one item in said aggregated data profile.

14. A computer-implemented method for collecting data related to the user and providing the user with control over the data, comprising:
providing, by a computing device, for a user to select one or more unaffiliated data sources to be accessed to collect the data;
collecting, on the computing device, said data from the unaffiliated data sources selected by the user, wherein the data comprises online and offline activities of a user from the unaffiliated data sources;
aggregating, on the computing device, said data collected from said unaffiliated data sources;
normalizing, on the computing device, said data into a standardized form;
generating, on the computing device, an aggregated data profile associated with said user based on said data from the normalizing operation wherein said aggregated data profile comprises characteristics of said user;
providing access, by the computing device, for the user to the aggregated data profile as generated by the generating operation for review by the user;
providing, by the computing device, the user with one or more controls to confirm one or more characteristics contained in the user's aggregated data profile, thereby forming user-confirmed characteristics;
providing, by the computing device, the user with one or more controls for the user to authorize release of said user-confirmed characteristics as contained in the user's aggregated data profile to one or more third parties without disclosing an identity of the user;
associating, by the computing device, a dynamically changing unique identifier with the user;
releasing, by the computing device, said user-confirmed characteristics to one or more third parties only when authorized by the user, wherein said releasing operation uses said dynamically changing unique identifier and does not disclose any personal identifying information of the user; and
providing, by the computing device, to the user one or more items of targeted content received in response to the releasing operation and the user-confirmed characteristics and in association with the dynamically changing unique identifier.

15. The method of claim 14, wherein said
operation of providing the user with one or more controls to confirm one or more characteristics contained in the user's aggregated data profile, further comprises:
providing, by the computing device, a data field indicating the unaffiliated data source which reported the characteristic.

16. The method of claim 14, wherein said collecting operation further comprises:
providing an application programming interface (API) on a network site associated with an unaffiliated data source for purposes of collecting at least one item of data.

17. The method of claim 14, further comprising:
securely storing, by the computing device, said aggregated data profile.

18. A system for collecting information relating to a user and providing the user with control over said information, comprising:
a computing device;
a user device in communications with the computing device;
an online platform enabled by said computing device configured to generate a plurality of data profiles for a plurality of users;
a collecting component enabled by said computing device for collecting a plurality of data relating to a user from a plurality of unaffiliated data sources as selected by the user through a graphical user interface operating on the user device;
an aggregation component enabled by said computing device for aggregating said data collected from said plurality of unaffiliated data sources;
a normalizing component enabled by said computing device for normalizing said data into a standardized form;
a user profile generator component enabled by said computing device for generating an aggregated data profile associated with said user, wherein said aggregated data profile comprises characteristics of said user as obtained from the unaffiliated data sources;
a component that provides a graphical user interface on the user device to display to the user one or more characteristics from the aggregated data profile of the user for review by the user;
a component that provides a graphical user interface on the user device, the graphical user interface having one or more controls for the user to selectively revise one or more characteristics of the user in the aggregated data profile to more accurately reflect the user's current characteristics, thereby forming user-revised characteristics;
a component that provides a graphical user interface on the user device, the graphical user interface having one or more controls for the user to authorize release of said user-revised characteristics as contained in the user's aggregated data profile to one or more third parties without disclosing an identity of the user by associating a dynamically changing unique identifier with the user; and
a component that provides a graphical user interface on the user device to display to the user one or more items of content received from said one or more third parties in response to the user-revised characteristics.

19. The system of claim 18, wherein the user device is a mobile phone.

20. The system of claim 18, wherein the user device is a laptop computer.
